(19) United States
(12) Patent Application Publication
(10) Pub. No.: US 2015/0127359 A1
(43) Pub. Date: May 7, 2015

(54) STRUCTURE AND METHOD FOR MOBILE HEALTHCARE MANAGEMENT

(71) Applicant: Nikki Iravani, San Jose, CA (US)

(72) Inventor: Nikki Iravani, San Jose, CA (US)

(21) Appl. No.: 14/072,753

(22) Filed: Nov. 5, 2013

(51) Int. Cl. G06F 19/00

(52) U.S. Cl. CPC G06F 19/3418
USPC 705/2

(57) ABSTRACT

A system to host an interaction platform for users comprising a network; a host computer; wherein the host computer is connected to the network wherein the host computer provides a healthcare management platform for one or more users to interact for the purpose of users interfacing management wherein the users are comprised of at least one healthcare provider user, at least one patient user, a mobile application interface module for the patient user to access the healthcare management platform, a dashboard interface module for the healthcare provider user to access the healthcare management platform, an appointment module allowing the patient user to request an appointment with the healthcare provider user via the mobile application interface module wherein the appointment module further allows the healthcare provider to respond to the appointment request via the dashboard interface module. In one embodiment, healthcare management platform is further comprised of a messaging module wherein the messaging module allows the patient user to communicate to the healthcare provider user and allows for the healthcare provider user to communicate to the patient user.

### INCORPORATION BY REFERENCE

This application claims the benefit of U.S. provisional patent application No. 61/801,701 “STRUCTURE AND METHOD FOR MOBILE HEALTHCARE MANAGEMENT,” filed Mar. 15, 2013, which is incorporated herein by reference in its entirety.

### FIELD OF THE INVENTION

The present invention generally relates to an electronic healthcare management system, and, more particularly, a mobile healthcare management system.

### BACKGROUND OF THE INVENTION

The most important step of an effective healthcare management system is to facilitate doctor-patient communication and office visits. The more streamline and convenience the process is, the easier it is for patients to manage and maintain their health. Unfortunately, it has been very cumbersome due to unavailable technologies and solutions.

Currently, when a patient wants to make an appointment for a doctor visit, the patient must first obtain the doctor's office number and address, and thereafter find a convenient time to telephone the office to make an appointment. This step could be a hassle and take time because locating a doctor and checking the doctor's credentials are time consuming and requires some effort. After the patient telephones the office, the patient engages in negotiations with the doctor's staff to find a date and time that is convenient for the patient and available on the doctor's calendar. After agreeing on an appointment, the patient must record the date and time down and remind herself of the appointment. The staff must also enter the appointment into the office's appointment management system , and make a courtesy reminder call to the patient one or two days before the appointment.

Even if this process goes smoothly without unanticipated events, such as the office being on a lunch break or the staff being busy and not allowing them to answer calls, it may take multiple attempts by the patient and staff to manage the scheduling of an appointment. If the process does not go smoothly, the parties must spend more time and effort to schedule an appointment. For example, if the patient does not catch a staff member when she first calls, and must leave a message, the staff member must call the patient back to make an appointment, and may engage in some telephone tag before they can talk to each other. Even when they catch each other on the phone, their schedules might not match and require them to search for an available date and time.

If the patient's schedule changes after making the appointment, she must call the office to cancel or reschedule the appointment. If the patient's schedule does not change, the patient must remember the date and time of the appointment. Usually, the staff makes one or more reminder calls to the patient. This can be another round of phone calls between the healthcare provider and patient.

This cumbersome process is exacerbating when the patient is traveling or has a busy lifestyle, which does not allow for finding a healthcare provider and making multiple phone calls for a single appointment.

Clearly, it takes a lot of time and effort to schedule an appointment for a patient in order to get the necessary medical attention and care for the patient. Thus, this cumbersome process likely discourages a person to seek medical attention, especially routine preventive services, which are not urgently needed, but important for the person's overall health.

Clearly, it is highly desirable to have a solution that reduces the time and effort required to obtain medical services. In recent years, with the growing population and number of medical services offered, recent surveys indicate that 56% of consumers like the idea of mobile healthcare, and 41% prefer care delivered via mobile devices. These consumers probably want the convenience and advantages they have enjoyed and are accustom to in their daily mobile activities and interactions with others. There is a demand by consumers for health management and connectivity with their healthcare providers that is accessible anywhere and anytime. Consumers want healthcare management software, such as cost aggregation, cost estimation, medication tracking, medication reminder, etc., at their fingertips.

Not only do patients demand for a mobile healthcare solution, healthcare providers also desire the same so they can provide easy access to their services and memorable experiences, and, thus, expand their referrals and encourage existing patients to continue seeking their services whenever needed. The providers also want an effective, discreet targeted promotion of their practices and products.

Furthermore, providers want analytic statistics of patients' healthcare needs to better develop their practices and product offerings.

### OBJECT OF THE INVENTION

Accordingly, one objective of this invention is to provide a healthcare management system on a mobile platform.

Another objective of this invention is to facilitate a patient-practitioner relationship management system on a mobile platform.

Yet another objective of this invention is to provide a bidirectional communication platform between healthcare providers and patients.

Yet another objective of this invention is to provide healthcare providers with a communication system that enables communication to patients anytime, anywhere.

Yet another objective of this invention is to provide a patient appointment management system on a mobile platform.

Yet another objective of this invention is to provide a promotion management system on a mobile platform.

Yet another objective of this invention is to provide an system that generates analytic statistics and metrics of patients' healthcare needs.

Yet another objective of this invention is to provide an intelligent healthcare provider search.

Yet another objective of this invention is to provide GPS-based healthcare provider search.

Yet another objective of this invention is to provide a bidirectional real-time messaging system.

Yet another objective of this invention is to provide better patient information management.

Yet another objective of this invention is to provide a way to migrate patient's information from legacy systems to an enhanced and robust management mobile platform.

### SUMMARY OF THE INVENTION

In one aspect of the invention, a system to host an interaction platform for users comprises of a network; a host computer; wherein the host computer is connected to the network wherein the host computer provides a healthcare management platform for one or more users to interact for the purpose of users interfacing management wherein the users are comprised of at least one healthcare provider user, at least one patient user, a mobile application interface module for the patient user to access the healthcare management platform, a dashboard interface module for the healthcare provider user to access the healthcare management platform, an appointment module allowing the patient user to request an appointment with the healthcare provider user via the mobile application interface module wherein the appointment module further allows the healthcare provider to respond to the appointment request via the dashboard interface module. In one embodiment, the healthcare management platform is further comprised of a messaging module wherein the messaging module allows the patient user to communicate to the healthcare provider user and allows for the healthcare provider user to communicate to the patient user. In one embodiment, the messaging module allows the patient user to communicate to the healthcare provider user via a real time messaging module in the mobile application interface module. In one embodiment, the messaging module allows the healthcare management user to communicate to the patient user via the dashboard interface module. In one embodiment, the messaging module allows the healthcare provider user to communicate to the patient user via email or SMS text messaging. In one embodiment, the healthcare management platform is further comprised of a promotion module wherein the promotion module allows the healthcare provider user to promote one or more offers to the patient user and allows the patient user to respond to the offers. In one embodiment, the promotion module allows the healthcare provider user to promote one or more offers to the patient user in real time and allows the patient user to respond to the offers in real time. In one embodiment, the promotion module allows a predetermined number of the offers wherein the patient user can respond to the offers.

In one embodiment, the healthcare management platform is further comprised of an analytical module wherein the analytical module analyzes activities of the patient user and the healthcare provider user and provides statics regarding the activities.

In one embodiment, the healthcare management platform is further comprised of a user database module wherein the user database module stores information regarding the patient user and allows the healthcare provider user to manage the information via the dashboard interface module. In one embodiment, the healthcare management platform is further comprised of a messaging module wherein the messaging module allows the patient user to communicate to the healthcare provider user and allows for the healthcare provider user to communicate to the patient user. In one embodiment, the healthcare management platform is further comprised of a healthcare provider user profile module wherein the healthcare provider user profile module contains information regarding the healthcare provider user and allows the patient user to view the information regarding the healthcare provider user. In one embodiment, the healthcare management platform is further comprised of a healthcare provider user locator module wherein the patient user can locate the healthcare provider user base on the distance between the healthcare provider user and the patient user. In one embodiment, the healthcare provider locator module further comprises of a pop-up messaging module wherein the pop-up messaging module automatically prompts requests to the patient user when patient user locates the healthcare provider user via the healthcare provider locator module. In one embodiment, the healthcare provider locator module further comprises a healthcare provider locator offering module wherein the healthcare provider locator offering module wherein the healthcare provider locator offering module promotes one or more offers. In one embodiment, the healthcare provider locator offering module promotes the offer when the patient user locates the healthcare provider user via the healthcare provider locator module.

In another aspect of the invention, a computer-implemented method for managing users interfacing between at least one patient user and at least one healthcare provider user is disclosed, the method comprising: a. providing a network; b. providing a host computer wherein the host computer is connected to the network wherein the host computer provides a healthcare management platform for one or more users to interact for the purpose of users interfacing management wherein the users are comprised of at least one healthcare provider user and at least one patient user, c. the healthcare management platform is comprised of a mobile application interface module for the patient user to access the healthcare management platform, d. the healthcare management platform is comprised of a dashboard interface module for the healthcare provider user to access the healthcare management platform, e. the healthcare management platform is further comprised of an appointment scheduling module allowing the patient user to request an appointment with the healthcare provider user via the mobile application interface module wherein the appointment module further allows the healthcare provider to respond to the appointment request via the dashboard interface module. In one embodiment, the healthcare management platform is further comprised of a messaging module wherein the messaging module allows the patient user to communicate to the healthcare provider user and allows for the healthcare provider user to communicate to the patient user. In one embodiment, the messaging module allows the patient user to communicate to the healthcare provider user via a real time chatting module in the mobile application interface module. In one embodiment, the messaging module allows the healthcare management user to communicate to the patient user via the dashboard interface module. In one embodiment, the messaging module allows the healthcare provider user to communicate to the patient user via email or SMS text messaging. In one embodiment, the healthcare management platform is further comprised of a promotion module wherein the promotion module allows the healthcare provider user to promote one or more offers to the patient user and allows the patient user to respond to the offers. In one embodiment, the promotion module allows the healthcare provider user to promote one or more offers to the patient user in real time and allows the patient user to respond to the offers in real time. In one embodiment, the promotion module allows a predetermined number of the offers wherein the patient user can respond to the offers. In one embodiment, the healthcare management platform is further comprised of an analytical module wherein the analytical module analyzes activities of the patient user and the healthcare provider user and provides statics regarding the activities. In one embodiment, the healthcare management platform is further comprised of a user database module wherein the user database module stores information regarding the patient user and allows the healthcare provider user to manage the information via the dashboard interface module. In one embodiment, the healthcare management platform is further comprised of a messaging module wherein the messaging module allows the patient user to communicate to the healthcare provider user and allows for the healthcare provider user to communicate to the patient user. In one embodiment, the healthcare management platform is further comprised of a healthcare provider user profile module wherein the healthcare provider user profile module contains information regarding the healthcare provider user and allows the patient user to view the information regarding the healthcare provider user.

In one embodiment, the healthcare management platform is further comprised of a healthcare provider user locator module wherein the patient user can locate the healthcare provider user based on the distance between the healthcare provider user and the patient user. In one embodiment, the healthcare provider locator module further comprises a pop up messaging module wherein the pop up messaging module automatically prompts requests to the patient user when patient user locates the healthcare provider user via the healthcare provider locator module. In one embodiment, the healthcare provider locator module further comprises a healthcare provider locator offering module wherein the healthcare provider locator offering module wherein the healthcare provider locator offering module promotes one or more offers. In one embodiment, the healthcare provider locator-offering module promotes the offer when the patient user locates the healthcare provider user via the healthcare provider locator module.

### BRIEF DESCRIPTIONS OF THE DRAWINGS

FIG. 1A is a screenshot of a dashboard in one embodiment illustrating how a healthcare provider or professional can set his or her schedule, delete schedule and set his or her office hours.

FIG. 1B is a screenshot of a mobile device showing the available time slots on a particular day.

FIG. 2 is a flowchart illustrating an exemplary process by which a user schedules a “New” appointment.

FIGS. 3A-3D are screenshots illustrating an exemplary healthcare provider search process.

FIGS. 4A-4G are screenshots illustrating an exemplary appointment scheduling process.

FIGS. 5A-5D are screenshots illustrating an exemplary appointment confirmation process.

FIGS. 6A-6D are screenshots illustrating an exemplary appointment rejection and altering process.

FIGS. 7A-7B are screenshots illustrating an exemplary appointment cancelling process.

FIG. 8 is a screenshot representing the archiving aspect of the system, where messages are archived after a certain period defined by the user.

FIGS. 9A-9B are screenshots illustrating an exemplary appointment reminder process.

FIGS. 10A-10C are screenshots illustrating an exemplary appointment scheduling process without using a mobile device.

FIG. 11 is a screenshot of a user management function of the system.

FIGS. 12A-12B are screenshots illustrating a note or message sending function.

FIGS. 13A-13B are screenshots illustrating an event reminder function.

FIG. 14A-14B are screenshots showing an exemplary pop-up dialog feature of a product or service promotion function.

FIGS. 15A-15B are screenshots illustrating a promotion management function.

FIGS. 16A-16B are screenshots further illustrating the promotion management function.

FIG. 17 is a screenshot showing backend functions of the system's user database.

FIG. 18 is a screenshot of the Address Book tab on the dashboard.

FIGS. 19A-19B are screenshots of an Online Chat function on the dashboard.

FIG. 20 is a diagram of the exemplary hardware and software for the system.

FIG. 21 is a diagram of one exemplary embodiment of the mobile healthcare management system.

### DETAILED DESCRIPTION OF THE INVENTION

The following detailed description of the preferred embodiments presents a description of certain specific embodiments as examples of a plurality of ways to practice this invention. As such, one may practice the present invention in a multitude of different embodiments as defined and covered by the claims.

In some instances, certain features are described in less or more detail. The level of detail associated with each of the elements or features should not be construed to qualify the novelty or importance of one feature over the others.

Certain marks referenced herein may be trademarks, whose use is to provide an enabling disclosure by way of example and shall not be construed to exclusively limit the scope of the disclosed subject matter to material associated with such marks.

References in this specification to “an embodiment”, “one embodiment”, “one or more embodiments” or the like, simply mean that the particular element, feature, structure or characteristic being described is in at least one embodiment of the disclosed subject matter. The occurrences of such phrases do not necessarily refer to the same embodiment, nor do they necessarily to mutually exclusive embodiments with respect to the discussed features or elements.

Various exemplary embodiments disclosed herein are directed to mobile healthcare systems that enable mobile connectivity between consumers and healthcare providers. While the eye care system is used herein to illustrate various features and advantages, the systems and methods disclosed herein are equally applicable to other specialty healthcare systems such as dental care, physical therapy, chiropractic care and others. As such the present invention is not intended to be limited to eye care.

In one embodiment, a mobile eye care platform having an App consumers can download to their GPS-capable mobile devices, i.e., smart phones, tablets, etc., and a dashboard that is installed on the computers at a provider's site, is provided. Various screen shots from the App and the dashboard will illustrate various aspects of this invention.

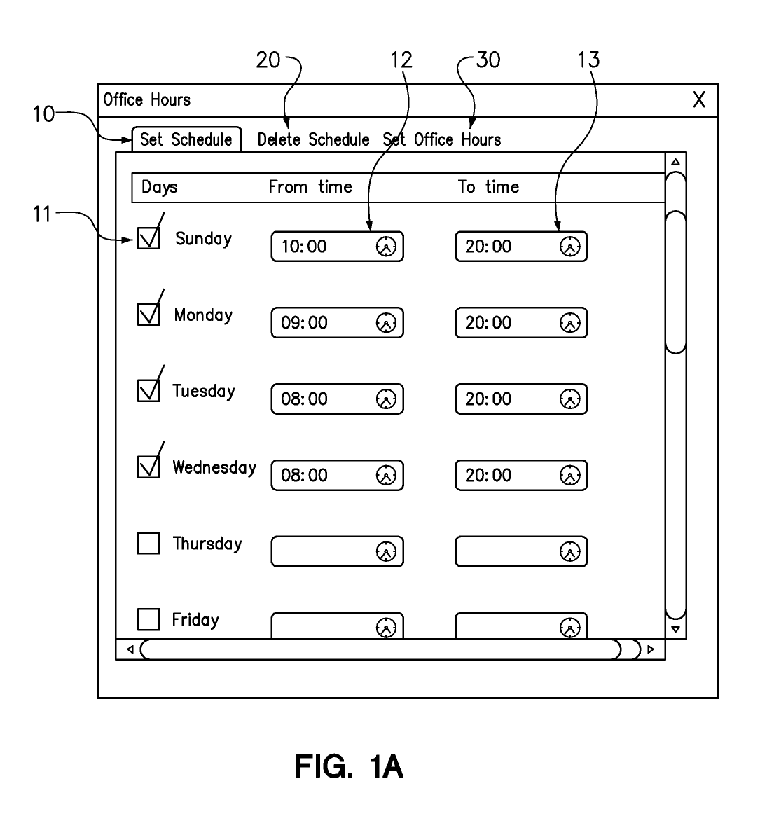

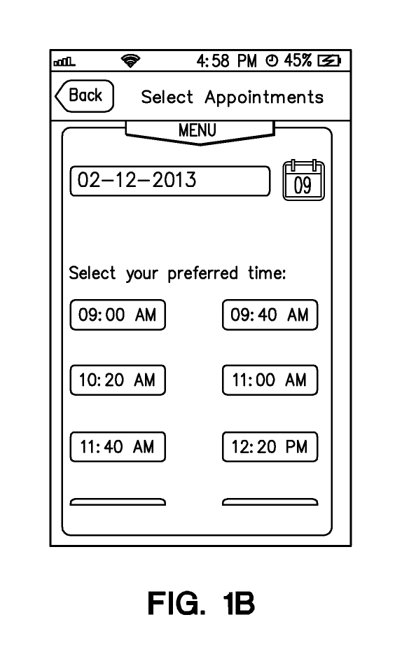

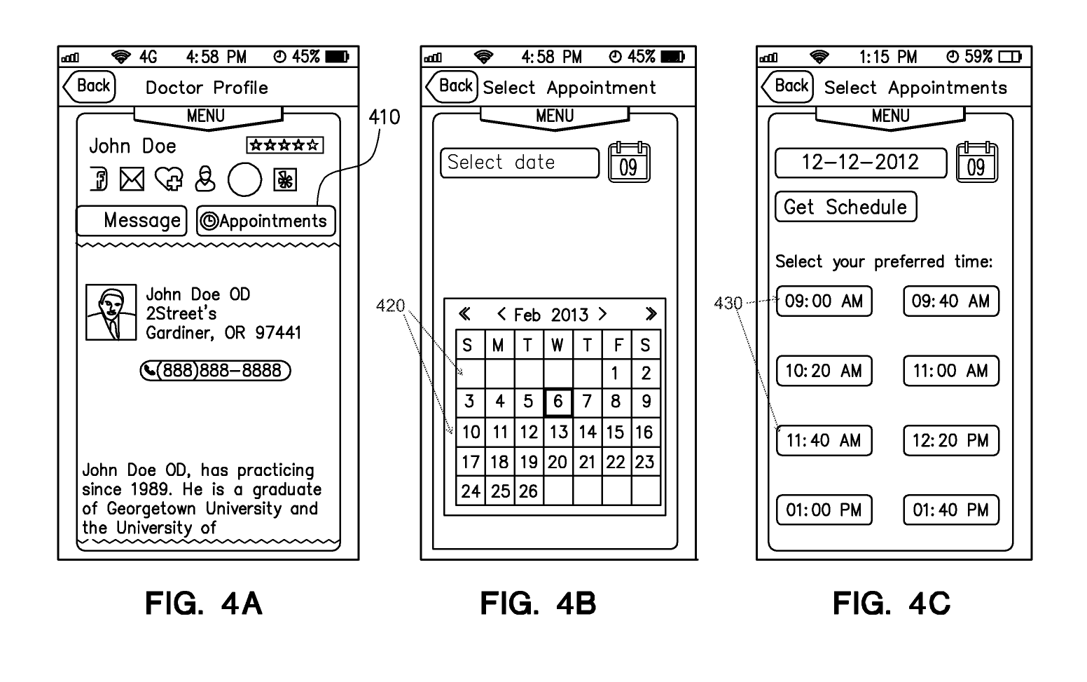

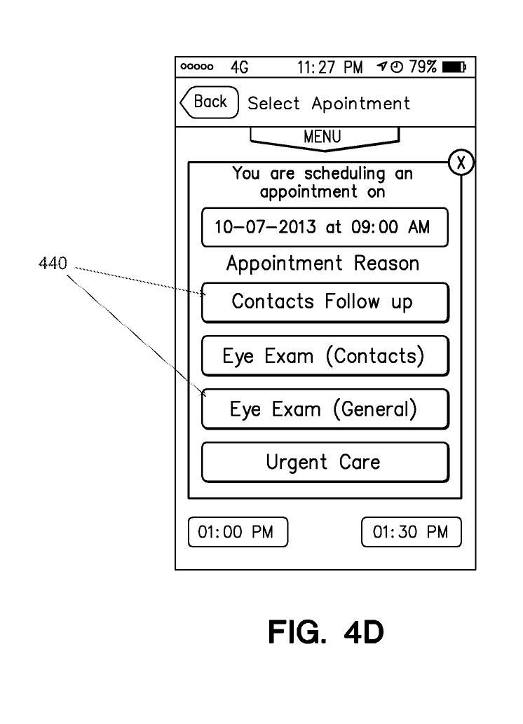

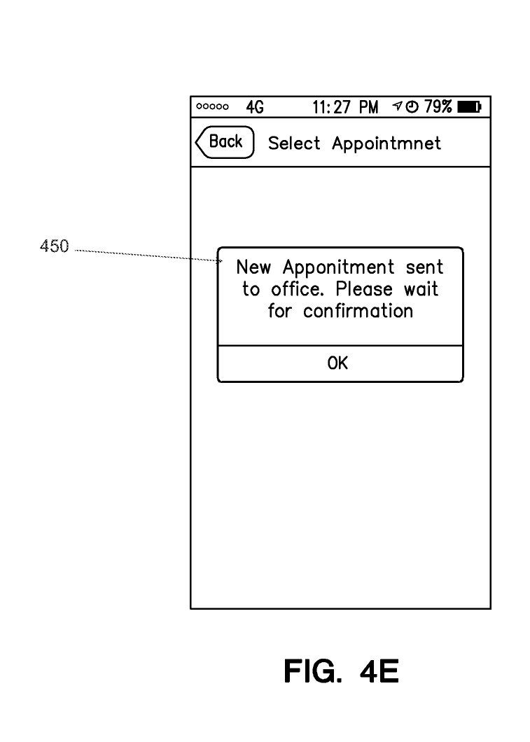

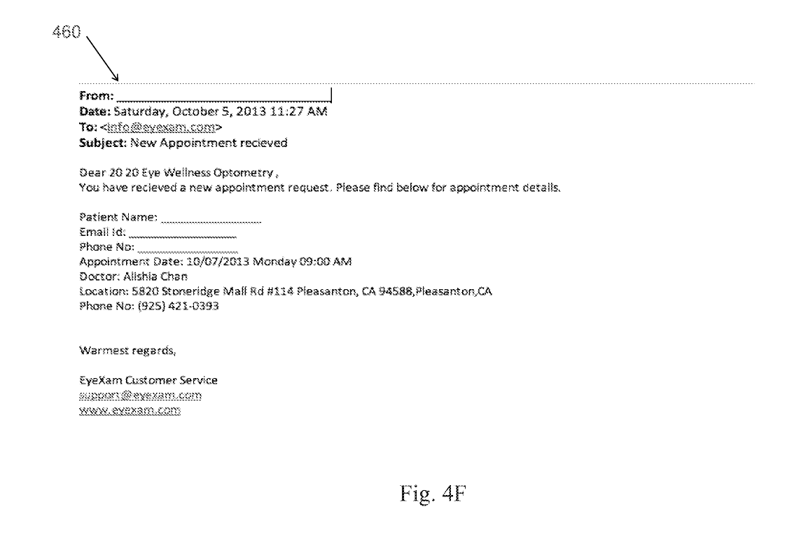

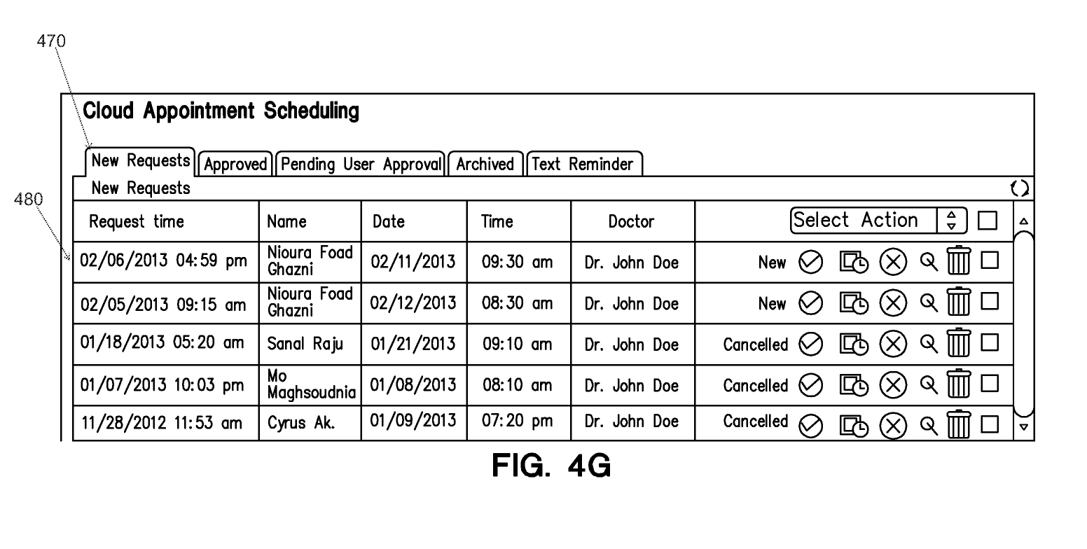

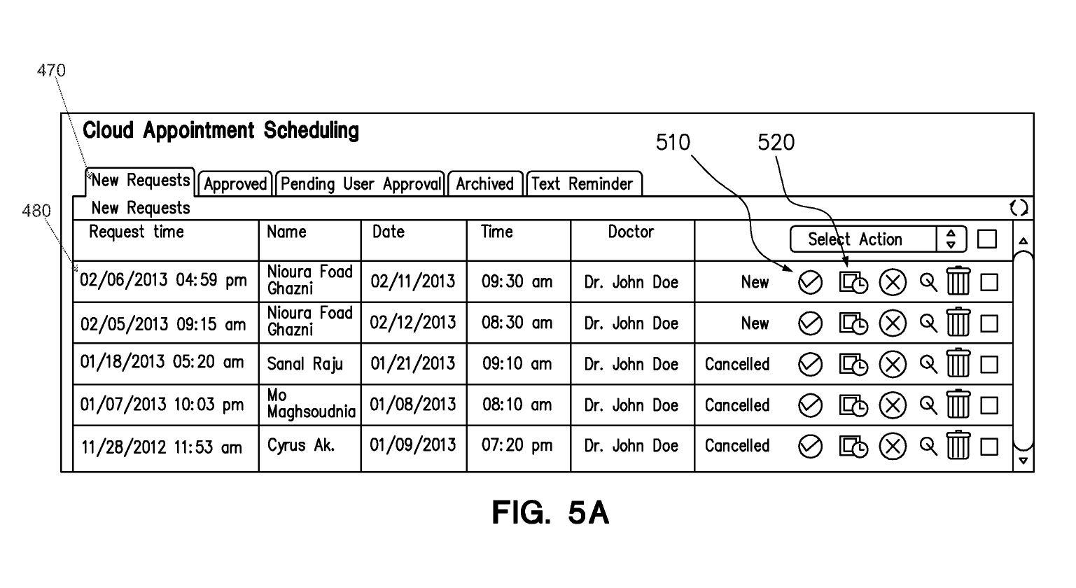

Referring to FIG. 1A, in one embodiment, a provider can set his or her working hours by selecting the Set Schedule tab 10, and adding days of the week by checking the checkboxes 11, and setting the working hours using the From Time and To Time calendar components 12 and 13. The provider can also change his or her working hours by selecting Delete Schedule tab 20. The provider can remove a day of the week from his or her schedule by unchecking checkboxes 11, or modify available hours for work using the calendar components 12 and 13. Similarly, the provider can set the office hours, when the provider is available in the office, by selecting the Set Office Hours tab 30. Once the practitioner has finalized the practitioner's schedule and the available office hours for patient visits, the system generates appointment slots that can be displayed by the App on the mobile device of a potential patient, as depicted in FIG. 1B, and FIG. 4C.

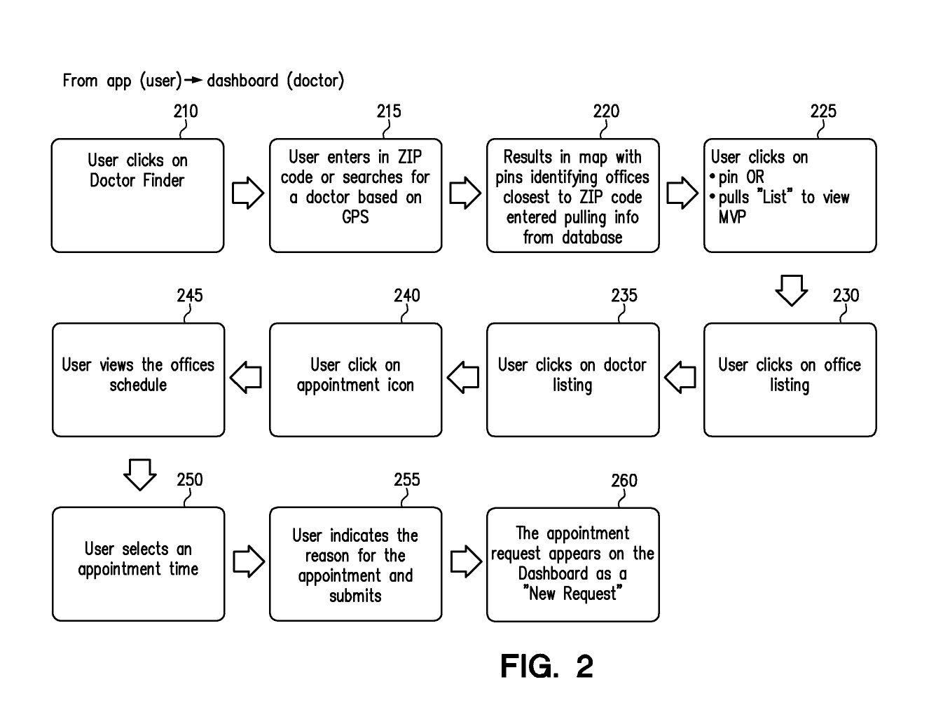

Referring to FIG. 2, in one embodiment, a user in need of a healthcare service can use the App to search for available providers within the patient's selected locale 210. The user can select the locale by entering in a specific zip code or use the location selector in one embodiment 215. The search results will display on a map with red pins identifying offices within the selected geographic area, or on a list with the closest office first 220. It is appreciated that there are a plurality of ways of presenting the search result within the scope of this invention and achieving the same result of representing the search result to the user. The user can select a pin on the map or a list item that is displayed on the “List” to select a specific office 230 and a doctor within that office 235, which displays the doctor's Mobile Virtual Profile (MVP) 225. In one embodiment, after the selected doctor's MVP is displayed, the user may then click on the appointment icon or button also displayed on the MVP window to start the process of scheduling an appointment 240. The doctor's calendar showing available and unavailable days is displayed to the user, who selects an available day to visit the office from the calendar 245. Next, the available appointment slots for the selected day are shown to the user, who can then select one of the available appointment slots to send an appointment request 250. The user is also prompted to indicate the reason for the appointment before submitting the appointment request 255. The appointment request and the user's pertinent information are sent to the appropriate handlers, e.g., the provider's staff, a third-party agency's staffs, and the information is also displayed on the selected doctor's dashboard as a “New” request 260.

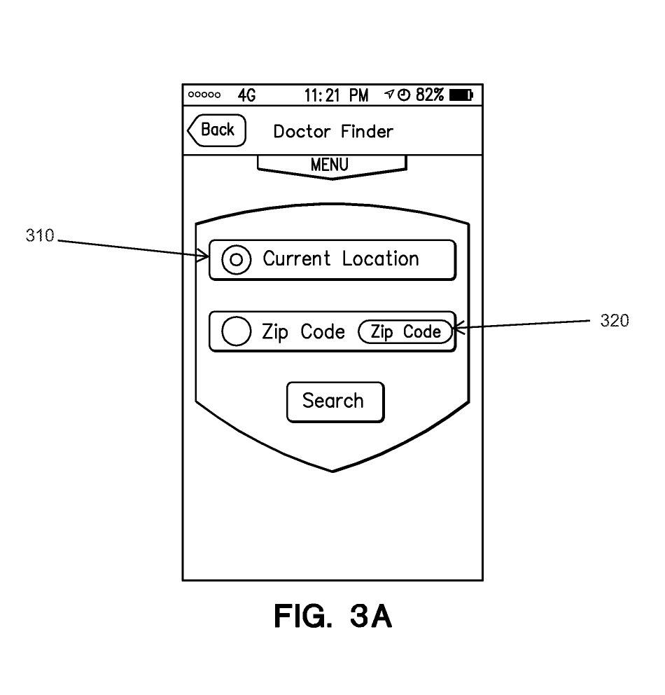

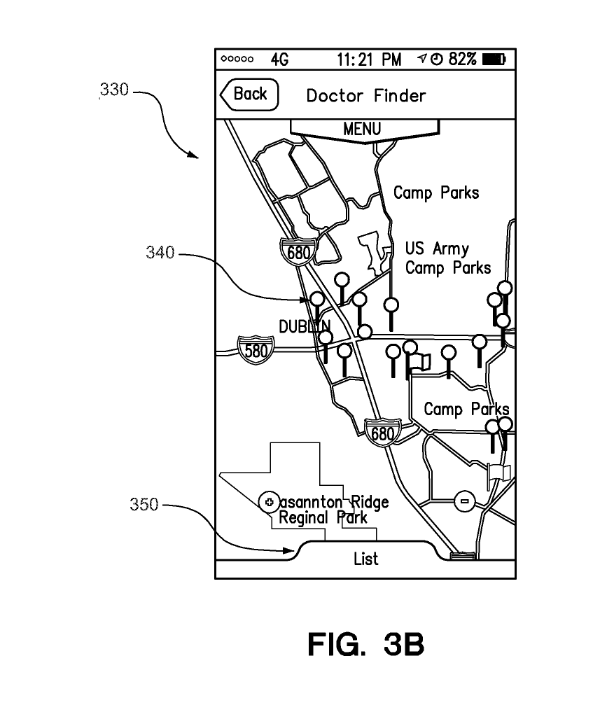

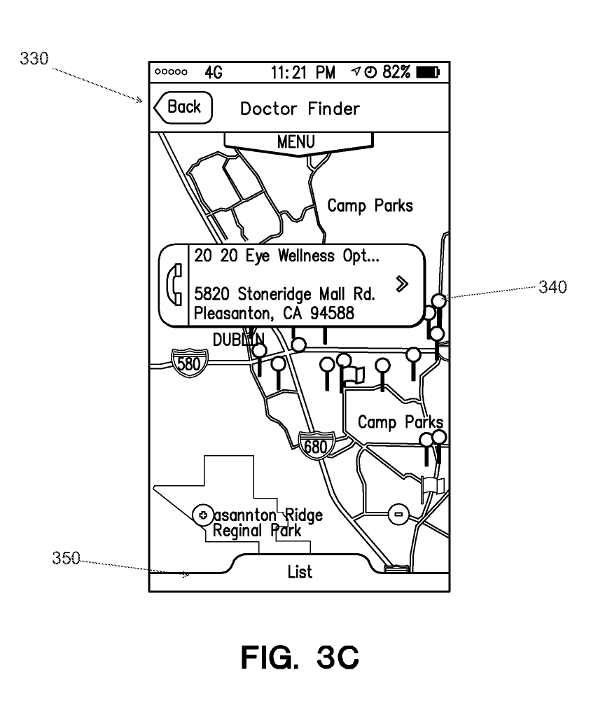

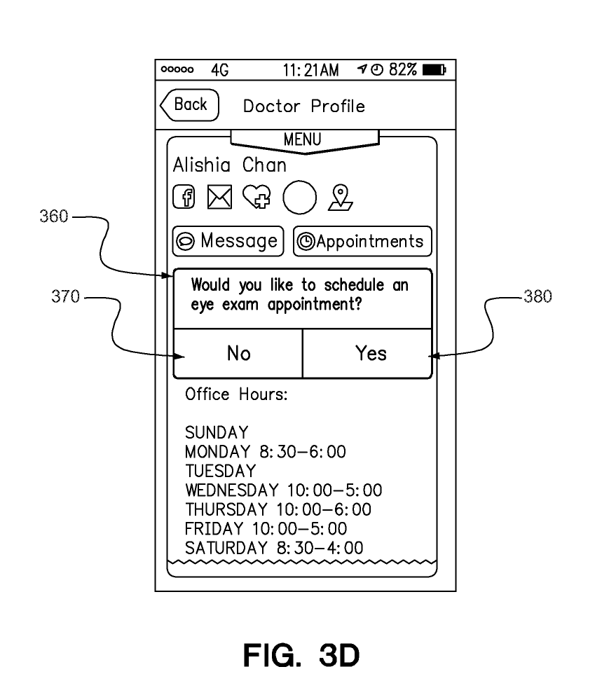

Referring to FIGS. 3A-3B, in one embodiment, a user can begin a search for a local eye-doctor by using the Doctor Finder feature of the App as depicted in FIG. 3A. The user can use the GPS service of the mobile device by selecting Current Location 310 or enter a specific zip code in the Zip Code box 320 to search for a local office. Given the zip code or the user's location, the information of the closest provider is pulled from the EyeXam database, and the office locations are marked on a digital map 330 with red pins or yellow flags 340 as depicted in FIG. 3B. The user can select an office by clicking on a red pin or yellow flag 340, or the user can pull the list of offices by clicking the List dropdown 350 at the bottom of the digital map. It is appreciated that the position of the dropdown list 350 can be customized.

In one embodiment, where GPS service is available, the App can automatically determine the patient's geographical location and limit the provider search to the available providers in the radius of 5, 10, 20 miles or a user-defined distance from the patient's current location. The GPS service is an equivalent method of selecting a locale.

Referring to FIGS. 3C-3D, in one embodiment, presented with a plurality of provider offices, the user can select an office profile or specific doctor by clicking on a red pin or yellow flag 340 on the digital map 330, or selecting a list item on the pull-down list 350, a pop-up dialog box 360 appears asking the user if an appointment is desired as depicted in FIG. 3D. If the user selects No 370, the pop-up disappears and the user is directed to the doctor's MVP. If the user selects Yes 380, the user is directed to the Appointment Scheduling feature of the app where the user can select a specific appointment date and time.

Besides the doctor's profile and contact information, a plurality of other functions are presented to users to further assist them in assessing healthcare provider's service. In one embodiment, as in FIG. 4A, the user may then select the appointment icon or button 410 to start the process of making an appointment. The office's calendar is presented as depicted in FIG. 4B showing available and unavailable days on tiles 420. The user selects a day the user wants to visit the office from the calendar by selecting a tile 420. The available appointment slots are shown to the user as in FIGS. 4C. The user can select one of the available appointment slots to make an appointment by selecting a button displaying the time 430. A pop-up dialog box appears as depicted in FIG. 4D to ask the user about the purpose of the visit, such as Contact Lens follow-up, eye exam, or urgent care, and other pertinent information for the visit, e.g., insurance carrier, allergies, etc. The user enters the appointment purpose by selecting a button 440. After entering the requested information, the appointment request is submitted, and the user is then directed to a confirmation page where the user receives a confirmation message 450 such as: “New appointment sent to office. Please wait for confirmation.” as depicted in FIG. 4E. Once this confirmation is displayed, no further action is required by the user. In one embodiment, the appointment information is sent over a wireless network to either the care provider or a third party booking agency, and an agent at the care provider office or third party booking agency schedules the appointment on behalf of the user. A confirmation email 460, similar to the sample email in FIG. 4F, is sent to the care provider's or the third party booking agency's office. The information is stored in the office's computer, or the computer's data storage, and displayed on the Dashboard under the New Requests tab 470 as a “New” request 480 as seen in FIG. 4G.

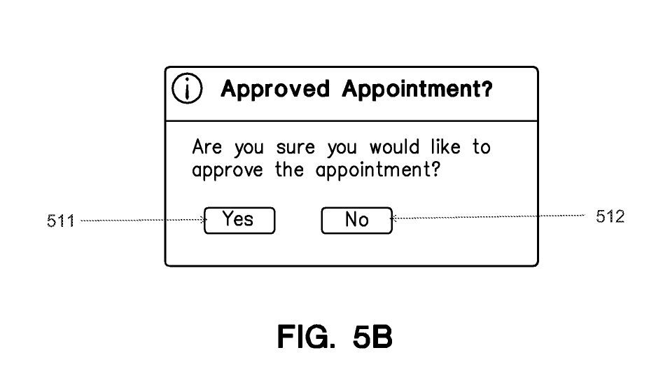

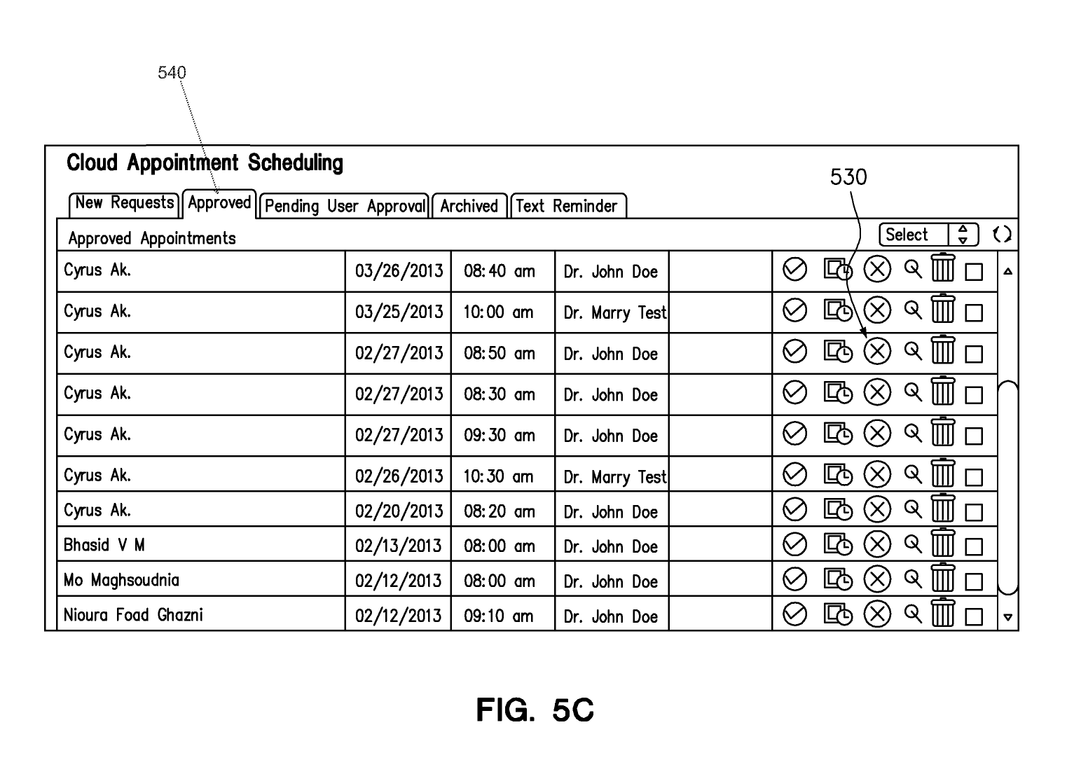

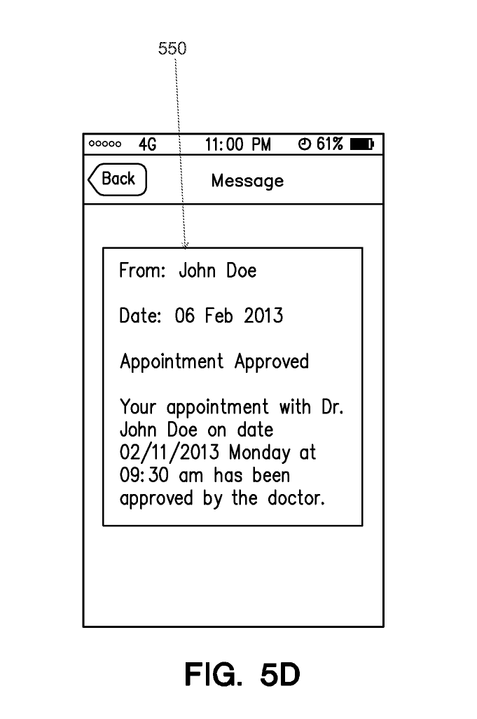

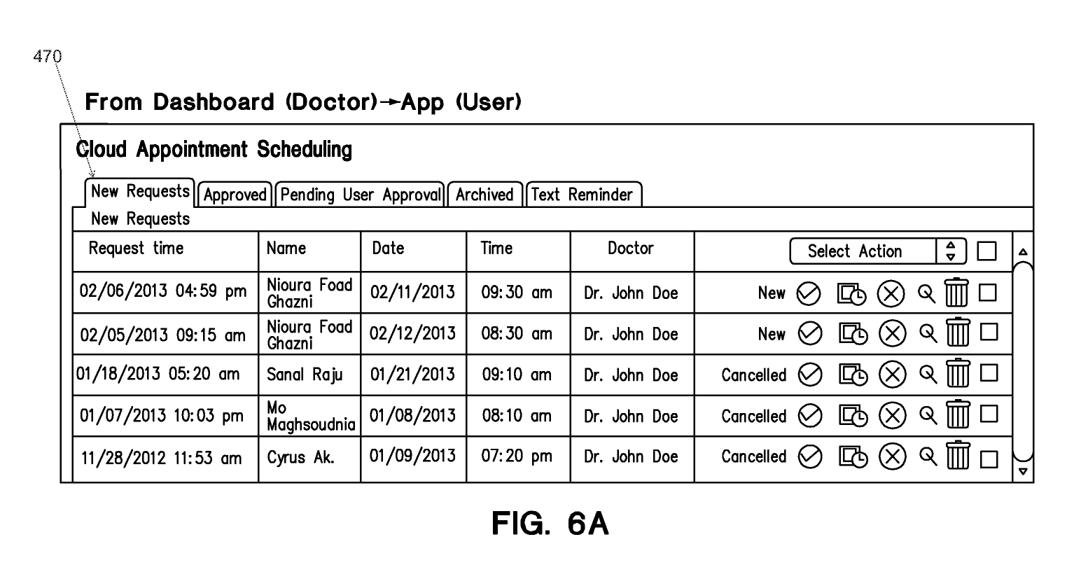

In one embodiment, on the doctor's dashboard, an appointment requested by a user appears as a “New” appointment request 480 under the “New Requests” tab 470 as shown in FIGS. 4G and 5A. The doctor is presented with a plurality of functions to assist the doctor and staff to manage appointments. A requested appointment can be accepted by selecting the green check icon 510 on the right next to the appointment listing. Upon accepting the appointment, a confirmation window pops open as seen in FIG. 5B and the appointment is confirmed by selecting Yes button 511, or unconfirmed by selecting No button 512. Upon confirming the appointment, the appointment is automatically moved to the “Approved” tab 540 as shown in FIG. 5C, and a message 550 confirming the appointment is sent to the user. An example of the message is shown in FIG. 5D. If the doctor or staff wants to move the appointment to different time slot, they can select the calendar icon 520 on the right of the appointment. They can also cancel an appointment by selecting the red “X” icon 530 on the right next to the calendar icon 520.

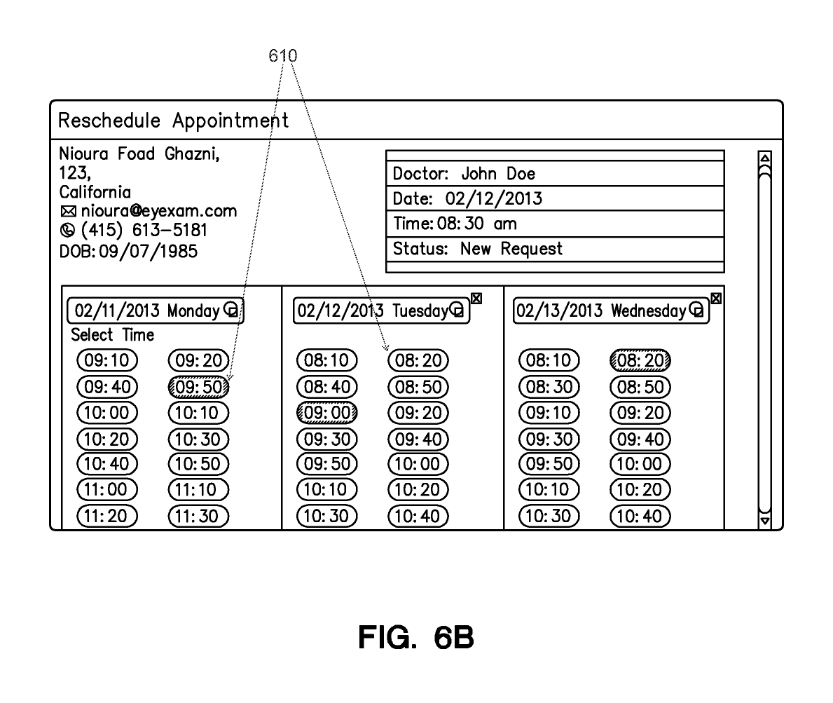

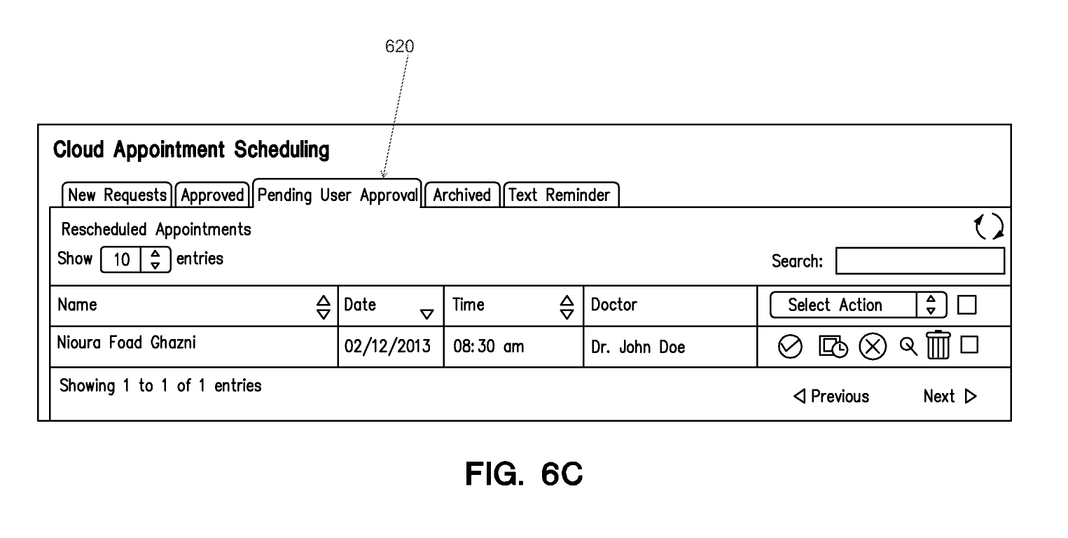

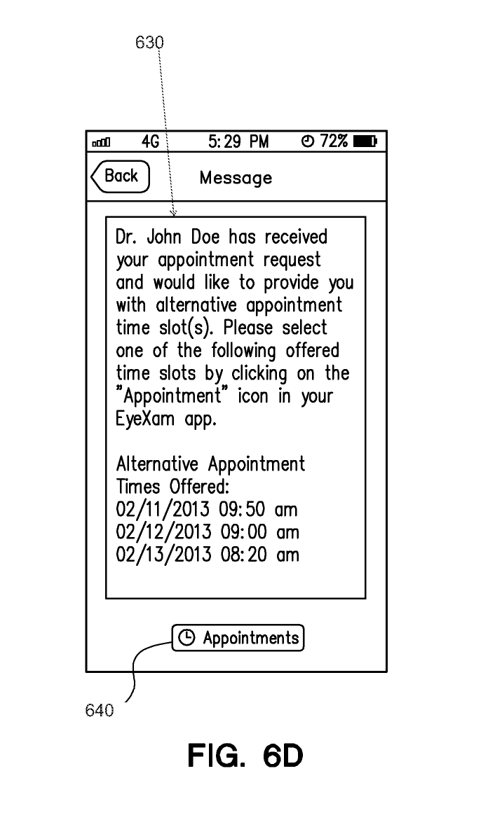

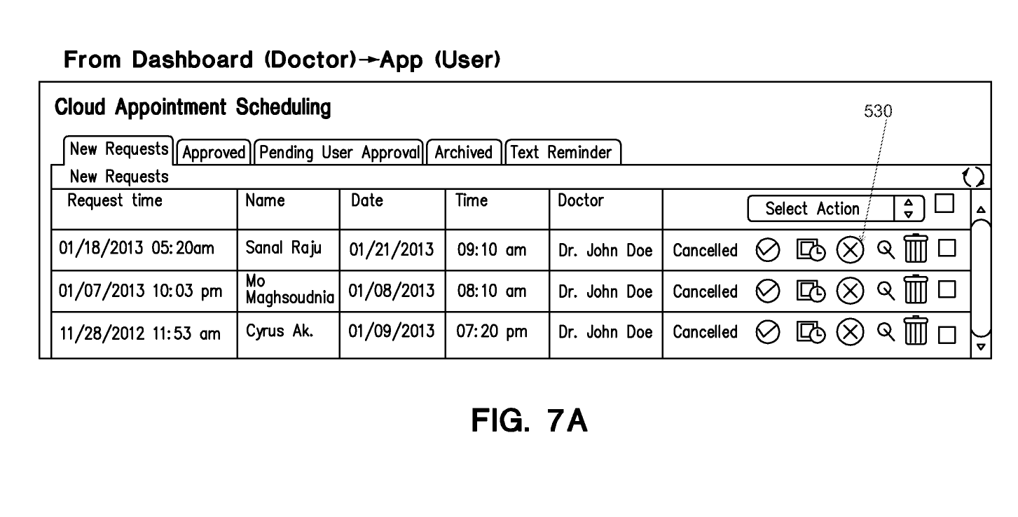

As depicted in FIGS. 6A-6D, in one embodiment, if the doctor or staff wants to move the appointment to a different time slot, they select the calendar icon 520 on the right of the appointment listing. A list of available time slots 610 is presented to them as illustrated in FIG. 6B. They select a few alternate time slots 610 by selecting the appropriate icons. Once done, the original appointment is automatically moved to the “Pending User Approval” tab 620 as seen in FIG. 6C. And a message 630 is sent to the user listing the selected available time slots as illustrated in FIG. 6D. The user can request one of the suggested time slots or a new one by selecting the Appointments icon 640 in FIG. 6D.

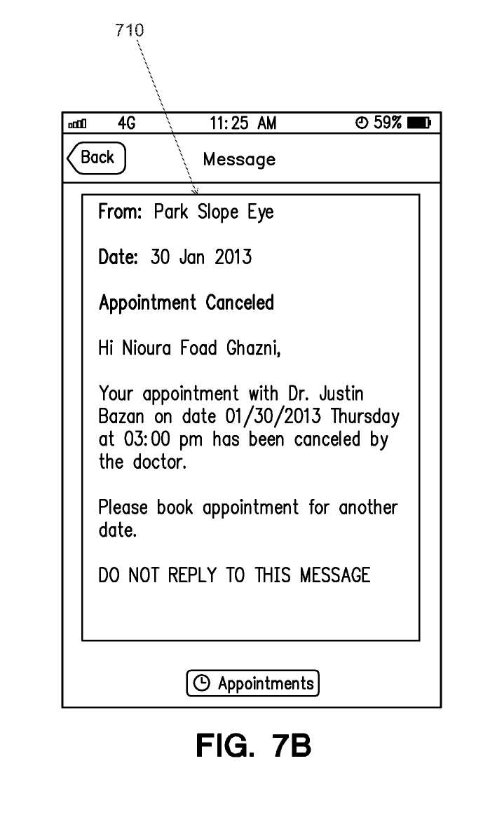

In one embodiment, after an appointment has been confirmed, if the doctor decides to cancel the appointment and ask the user to make an alternate appointment, the doctor can cancel the appointment through the dashboard by selecting the red “X” icon 530 on the right next to the appointment listing as seen in FIGS. 5C and 7A. A message 710 is automatically sent to the user indicating that the previously scheduled appointment is canceled, and asking the user to make an alternate appointment as illustrated in FIG. 7B. The appointment's status is changed to Cancelled, which is displayed next to the appointment, as shown in FIG. 7A.

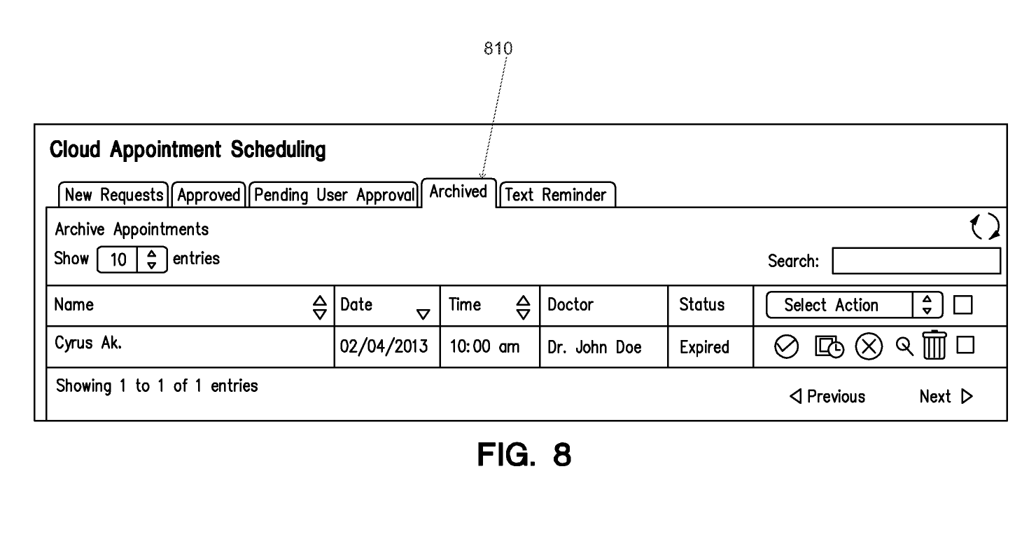

In one embodiment, once an appointment time has passed, the appointment is automatically archived under the “Archived” tab 810 as illustrated in FIG. 8. An “Expired” status is appropriately displayed.

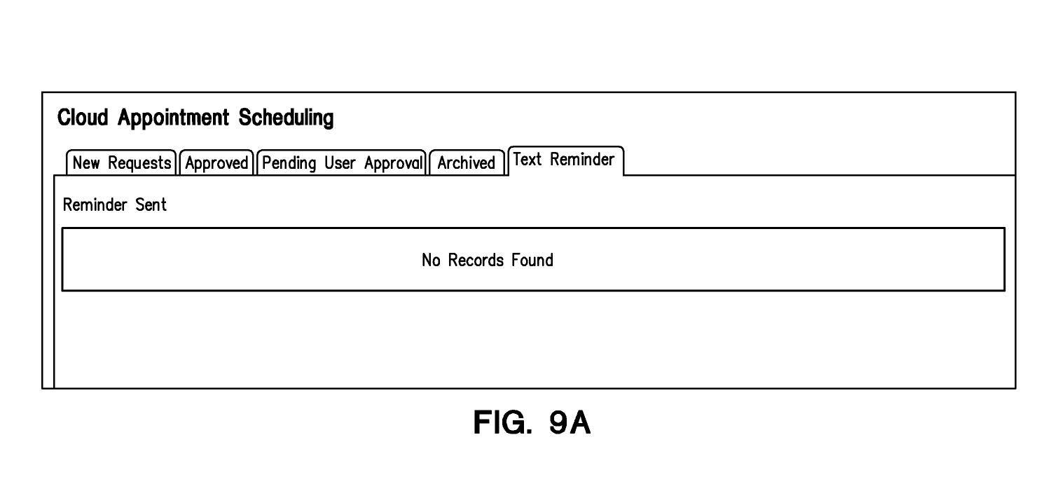

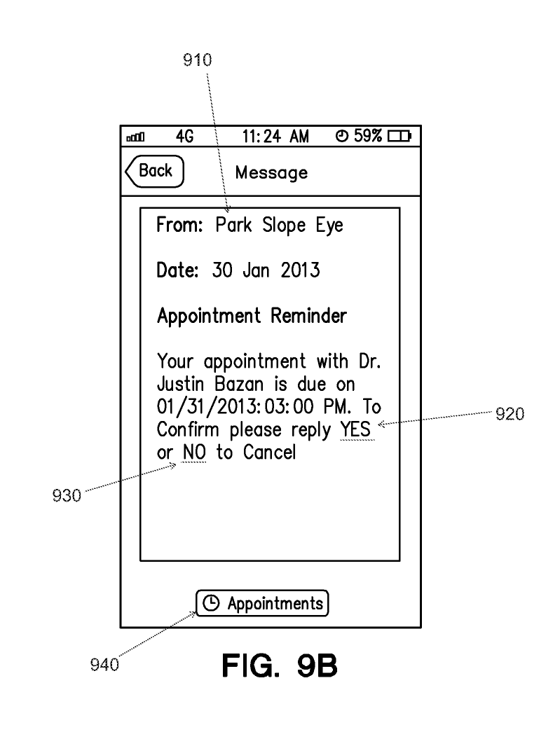

Referring to FIGS. 9A-9B, in one embodiment, a text reminder 910 is automatically sent to the user when an appointment is coming up. The user has a chance to confirm or cancel the appointment by selecting the anchor texts Yes 920 or No 930, respectively, as depicted in FIG. 9B. It is appreciated that there is a plurality of methods to implement the Yes and No options. The user can also request a new appointment by selecting the Appointments button 940.

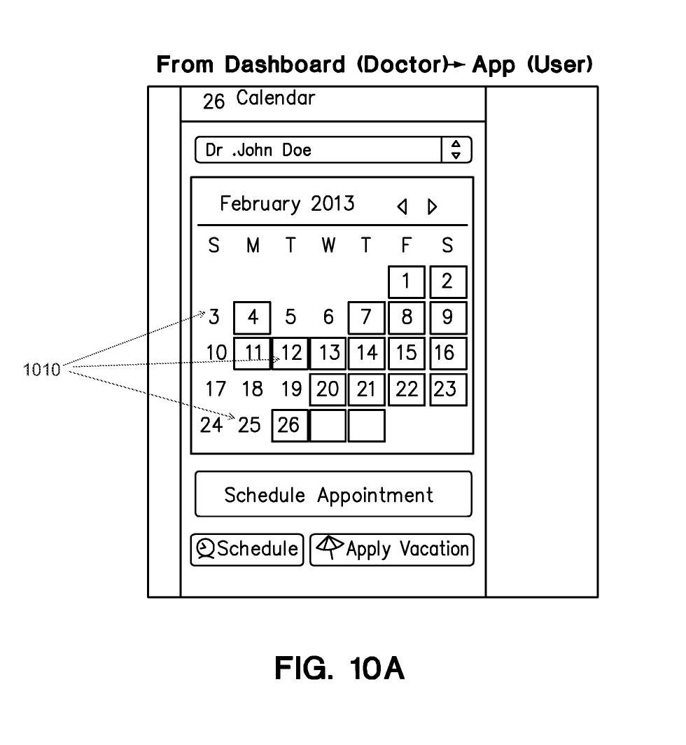

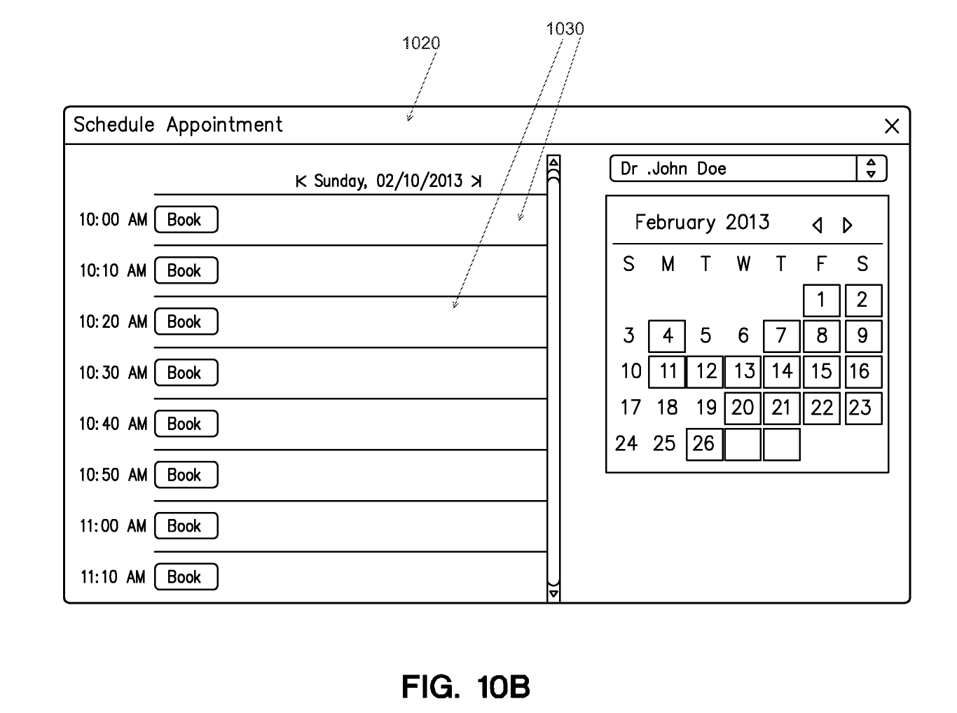

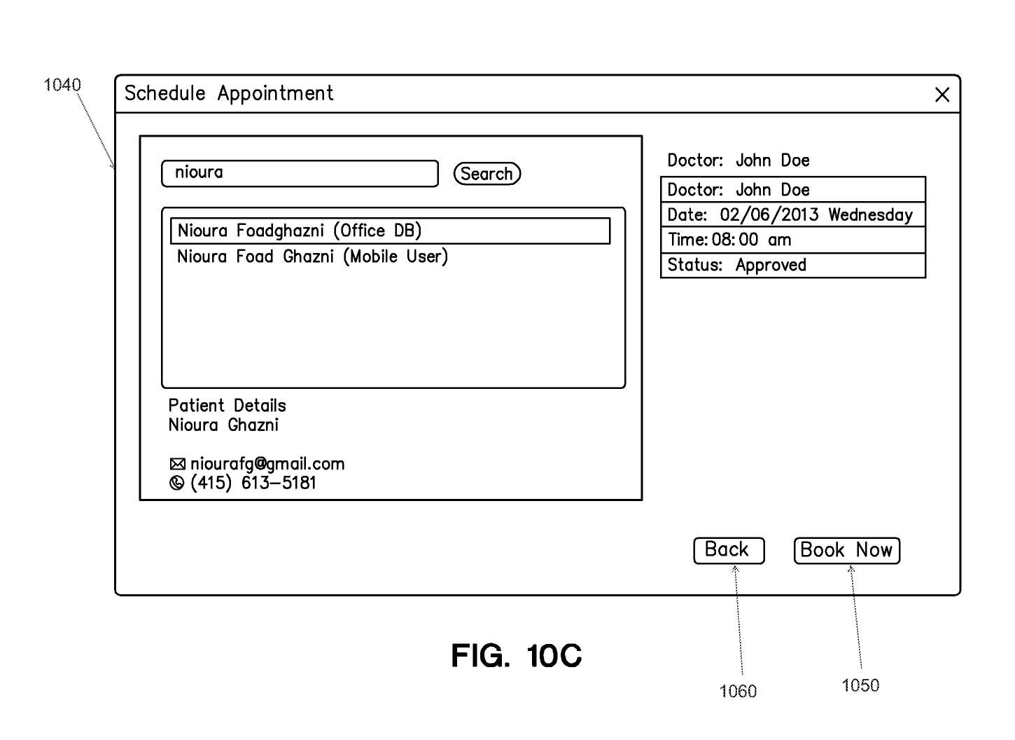

Referring to FIGS. 10A-10D, in one embodiment, it is appreciated that the doctor or staff can make an appointment for a potential patient at the person's request without using the App. The Dashboard allows the doctor to manually schedule appointments. The patient could communicate the person's appointment request via telephone, email, etc. The doctor or staff, upon receiving the communication message, opens the doctor's calendar that is represented with tiles 1010 like the equivalent example illustrated in FIG. 10A. The doctor or staff then selects a day on the calendar by selecting a tile 1010 to open up the dialog box 1020, as illustrated in FIG. 10B, displaying the available time slots for the selected day. The doctor or staff then selects the available time slot 1030 the patient requested. A dialog box 1040, as depicted in FIG. 10C, appears to show the appointment information, such as the patient's information, the doctor's information, the appointment's date and time, etc. The dialog box 1030 also contains Book Now button 1050 and Back button 1060. Upon selecting Book Now button 1050 and booking the appointment, the doctor or staff schedules the appointment, which will automatically appear on the doctor's calendar, and a message is automatically sent to the user confirming the scheduled appointment as depicted in FIGS. 10D. If Back button 1060 is selected, the doctor or staff cancels this scheduling attempt, and is redirected back to dialog box 1020 to select another time slot.

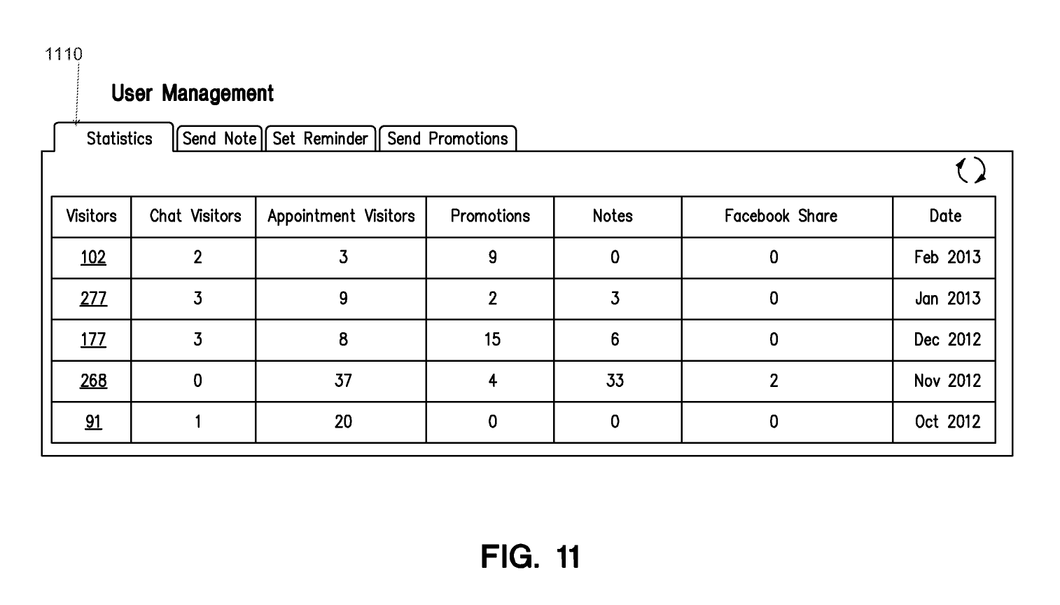

Referring to FIG. 11, in one embodiment, the system also collects system usage data, such as the number of all registered users who have viewed that office's MVP, the actions they have taken (e.g., messages, appointments, promotions, notes or Facebook shares) per month, etc. A registered user is one who downloads the App and registers with their email address and/or phone number. The intelligent information is tabulated in the Statistic tab 1110 of the User Management function of the system. By aggregating intelligent information, the system provides insight into the need of their patients and how to better serve them. It is appreciated that a plurality of usage and business metrics can be provided in the same or equivalent manner as illustrated in FIG. 11.

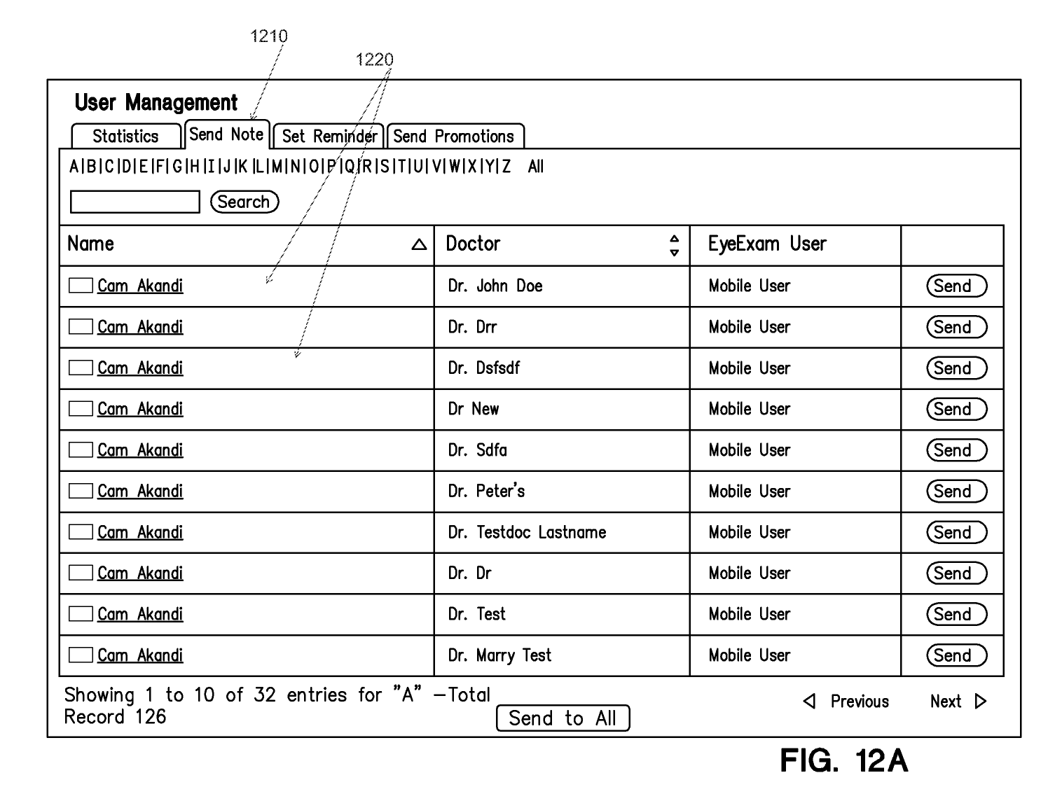

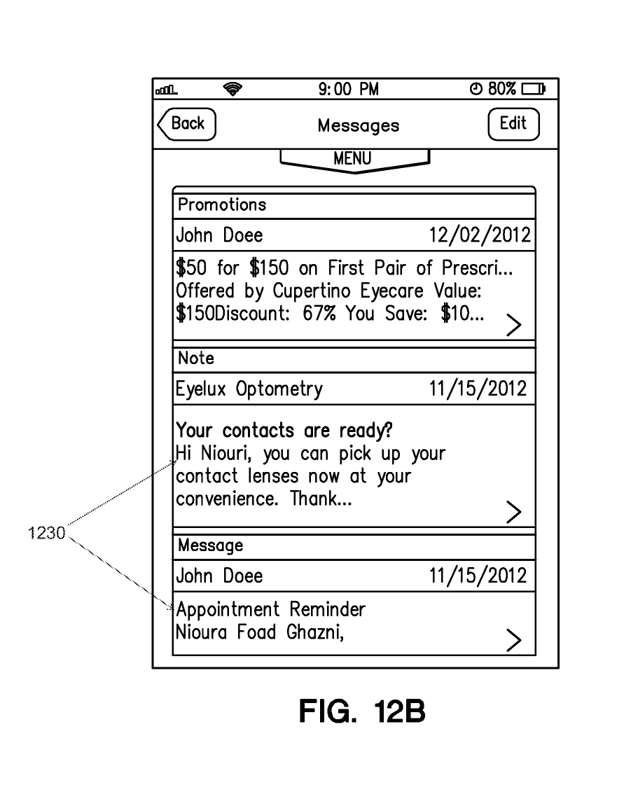

In one embodiment, the doctor or staff can send notes, such as “your contact lenses are ready for pickup,” to patients through the Send Note tab 1210 of the Dashboard as illustrated in FIG. 12A. The messages or notes 1230 can be sent to the patients' email Inbox or their handheld device as illustrated in FIG. 12B. The system enables the doctor and staff to simultaneously send notes to multiple users displayed on the Send Note tab 1210 by selecting a multiple of list items 1220. The system automatically retrieves the selected users' preferred communication methods input by the users at registration for using the App or an office visit. At the minimum, users can select among three types of communication methods: SMS, email and push notifications. Regardless the selected type, copies of the messages are stored in the Inbox of the user's App.

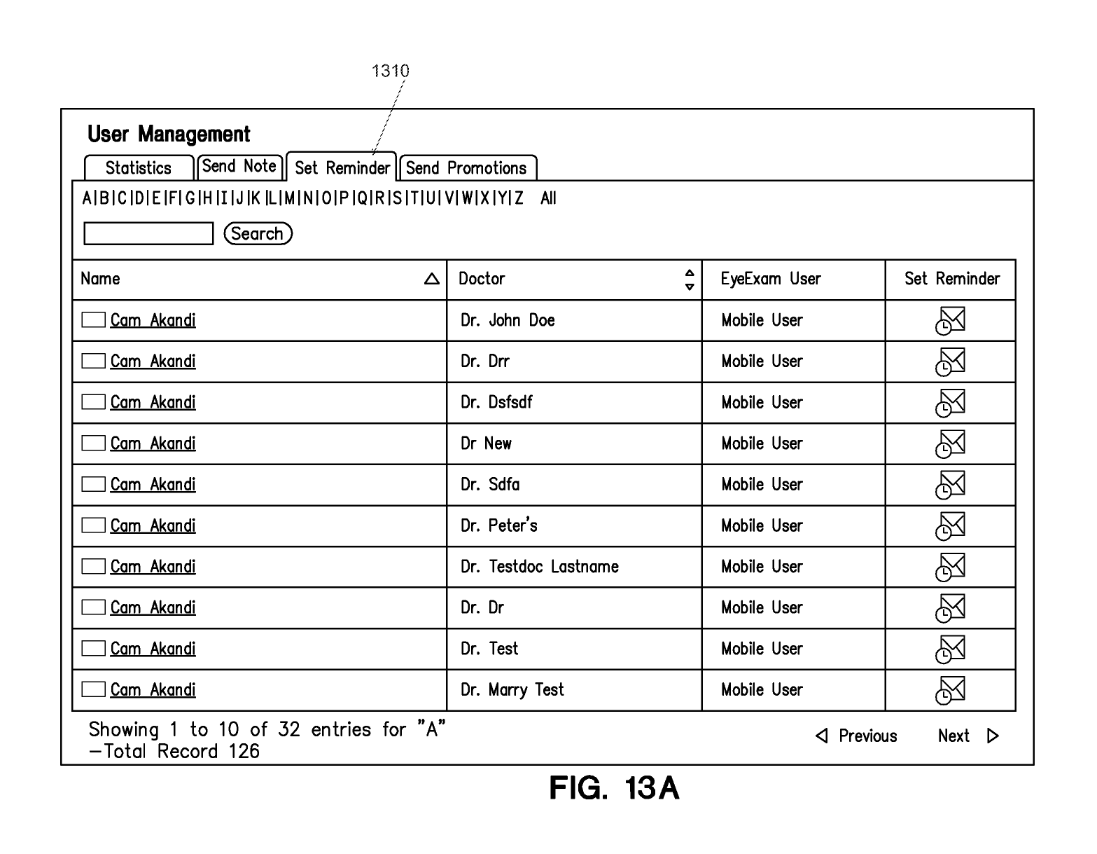

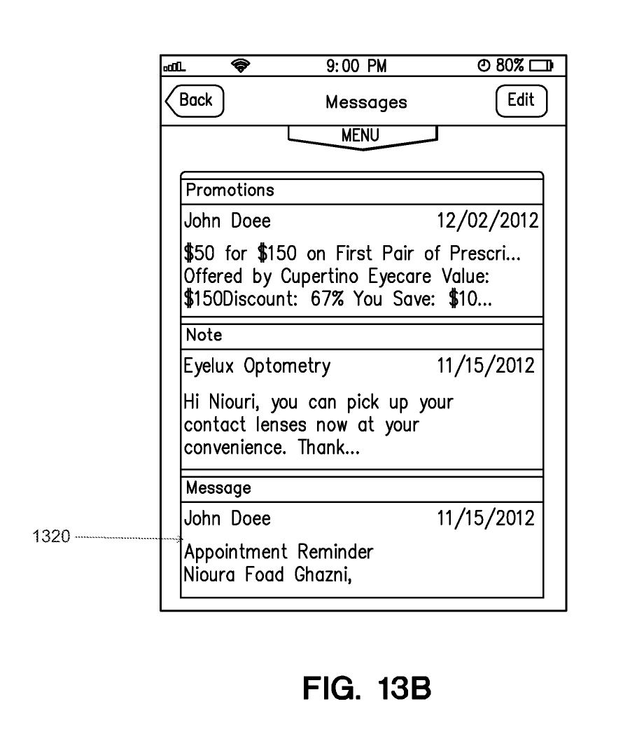

Referring to FIG. 13A-13B, in one embodiment, the doctor or staff can set a specific reminder to be sent out to a user on a specific date and time by selecting the Set Reminder tab 1310 as illustrated in FIG. 13A. The reminder includes a specific message to be automatically sent to the user when the set date and time is due. The message 1320 is displayed on the user's mobile device as illustrated in FIG. 13B.

In one embodiment, the doctor or staff can set up an automatic reminder for all appointments. The reminder includes a message showing relevant information, such as the appointment date and time, the office contact information and address, etc. The reminder also presents an option to Cancel the appointment. Without a cancelation, confirmation is assumed.

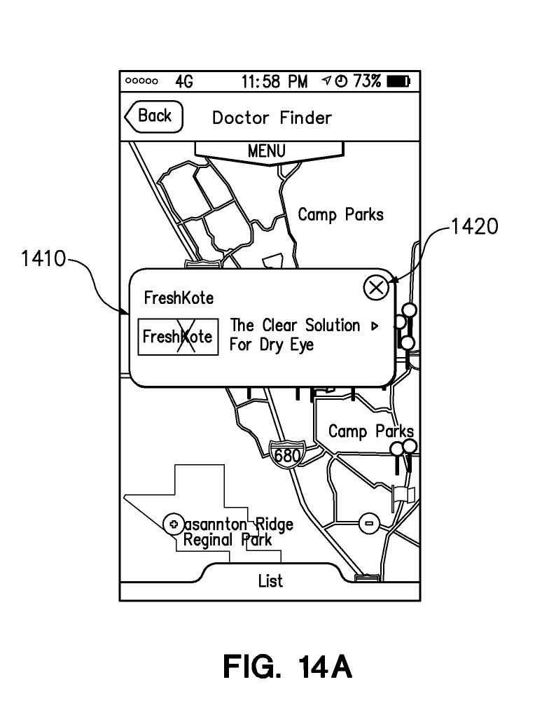

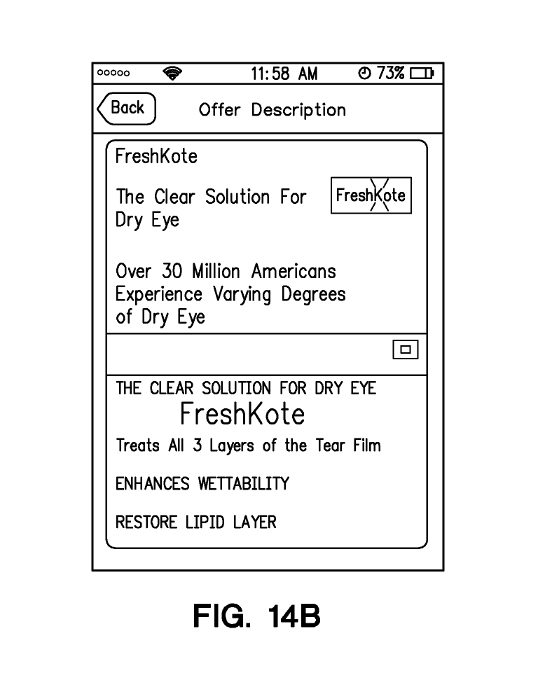

Referring to FIGS. 14A-14B, in one embodiment, in addition to displaying a provider search result on a digital map as in FIG. 3B, a pop-up dialog box 1410 appears with information relating to a promotion, e.g., coupons, ads, from the Offers section of the App. If the user clicks on the pop-up dialog box, the App redirects the user to the promotion as depicted in FIG. 14B. If the X-icon close button 1420 in the top right corner is selected, the pop-up disappears and the user is able to continue selecting a provider from the search result.

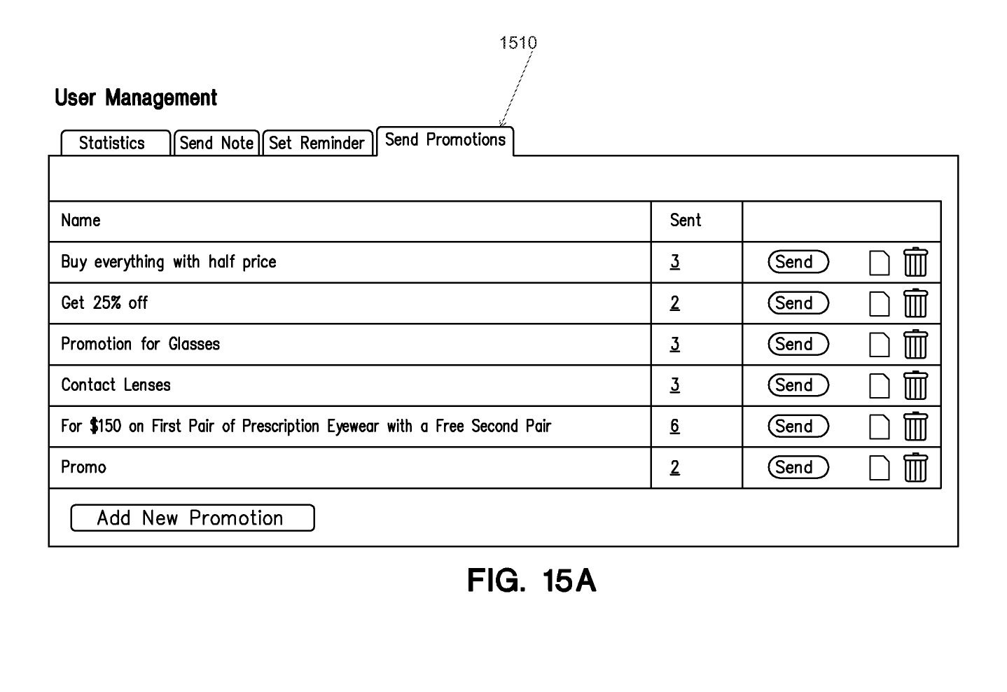

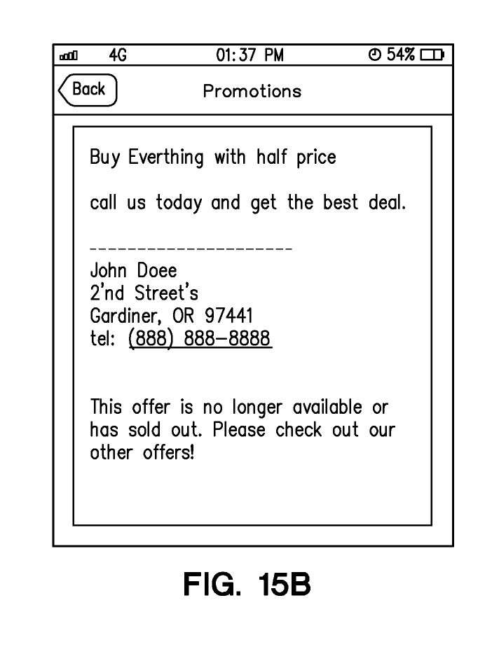

In one embodiment, real-time promotions can be set and sent via the Send Promotions tab 1510 of the dashboard as illustrated in FIGS. 15A. Once created and sent, the promotions will be displayed on the user's mobile device upon the user's selecting the “Promotions” button on the MVP display. The promotion's content is displayed as illustrated in FIG. 15B.

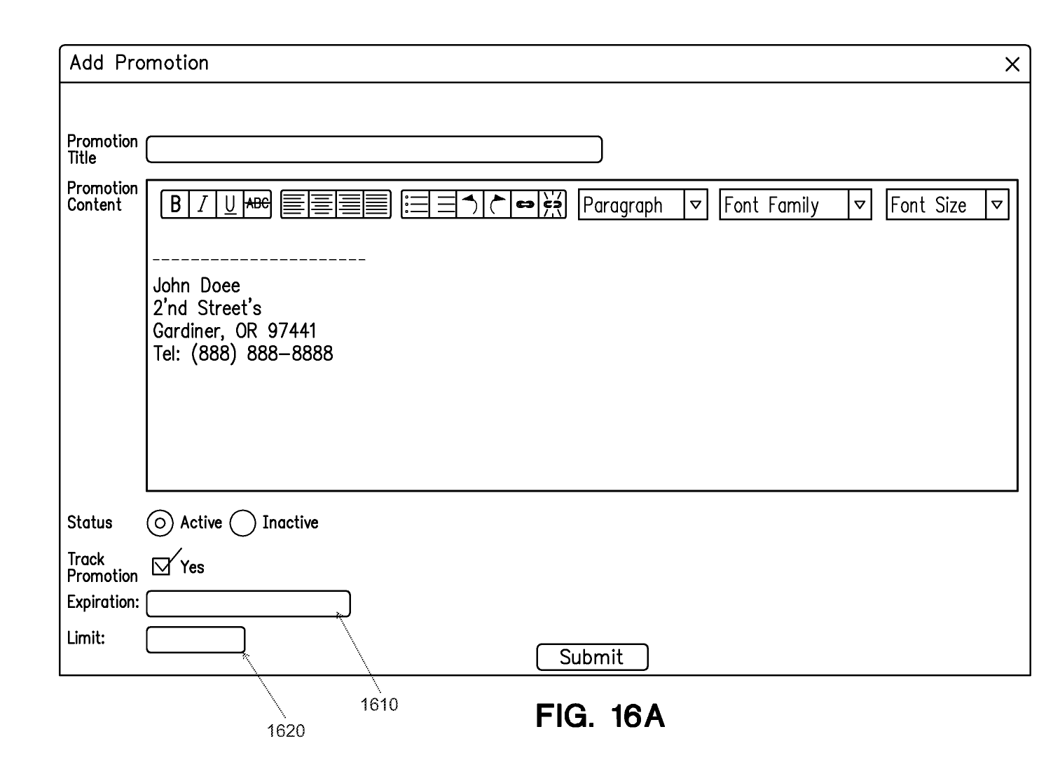

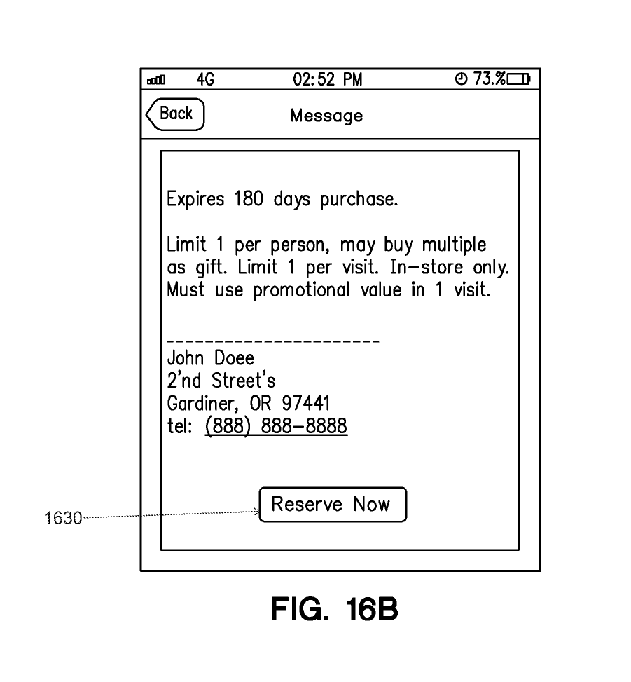

Referring to FIGS. 16A-16B, in one embodiment, through the Dashboard, an office can allow users to “reserve” a promotion where the promotion is limited by the number of the earliest responses, e.g., first 500, or before an expiration time. When creating the promotion, the office can set an expiration date and time in the box 1610 or enter a maximum number of the reserved spots in the box 1620, or do both to end the promotion when either condition meets. A counter or timer is provided by the system to track the conditions until one of them is met as users click on Reserve Now button 1630, as illustrated in FIG. 16B.

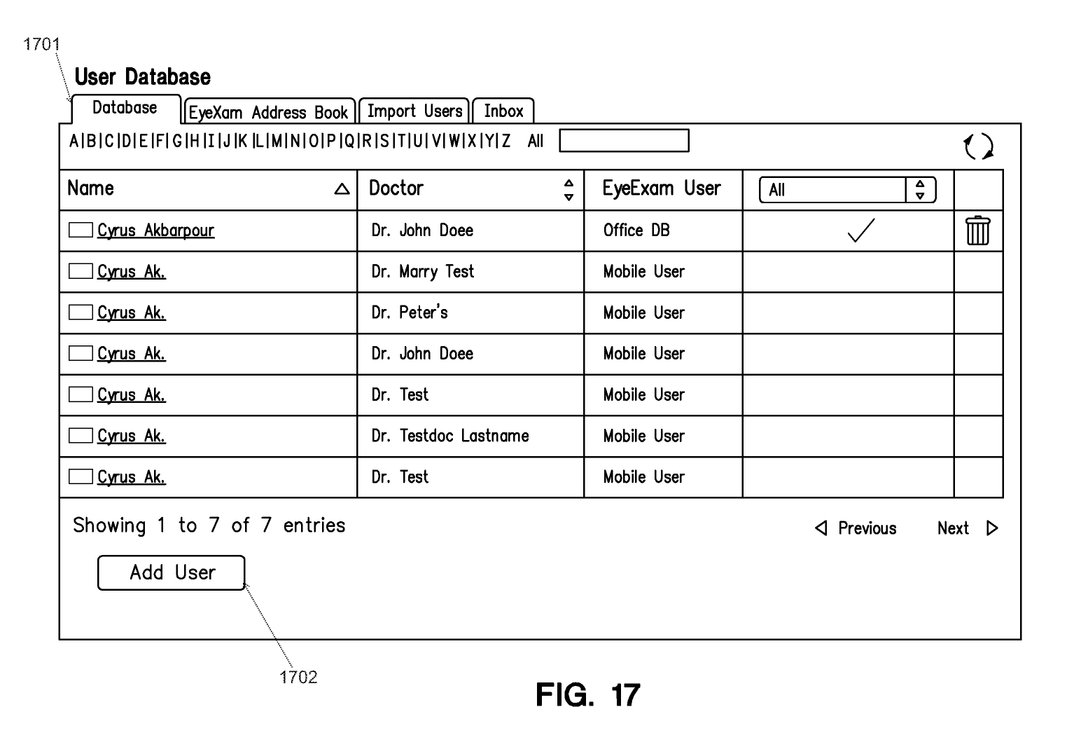

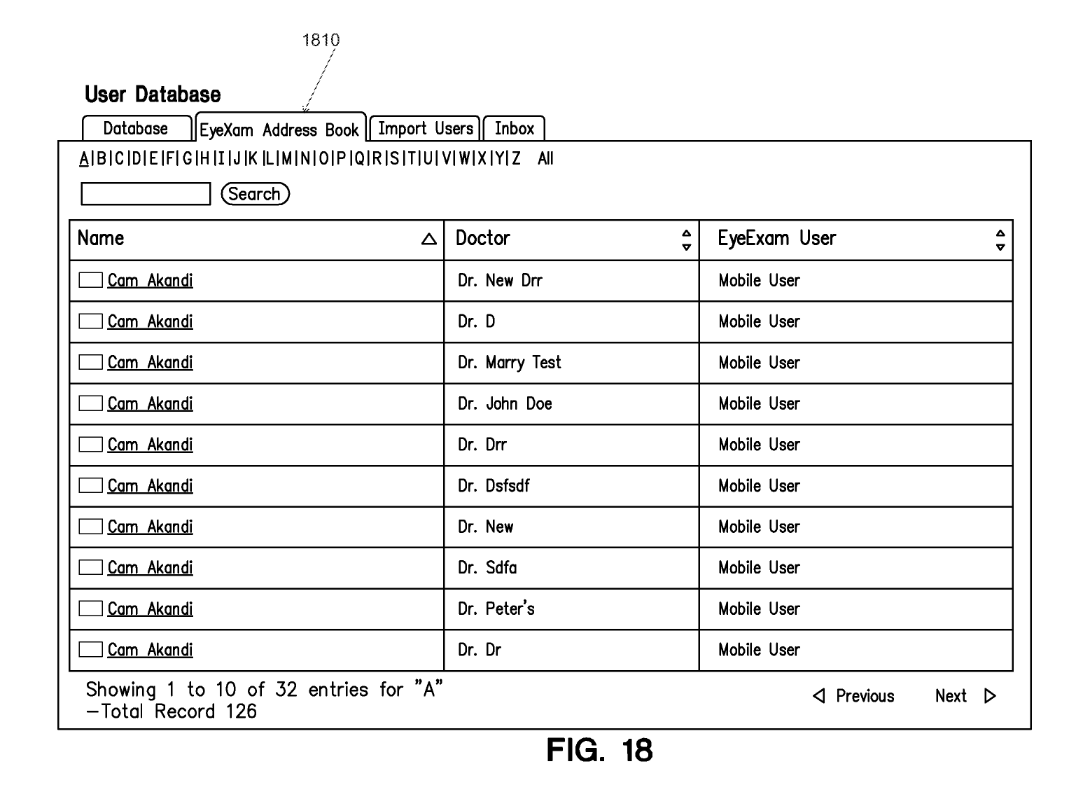

In one embodiment, all registered users' information is stored in a user database, as illustrated in FIG. 17, under the Database tab 1701. An office can also add a user manually by selecting Add User button 1702. Users' or patients' contact information is also displayed on the Address Book tab 1810 as illustrated in FIG. 18. Besides contact information, the database stores all pertinent information allowing the office to manage appointments, to send SMS, email and/or push notification messages to the registered users.

In one embodiment, the system provides a function to upload legacy address books into the Dashboard. The system verifies which of those patients are currently EyeXam users and links the address book entries thereof as registered users, and saves the doctor's MVP into that user's EyeXam app as a “favorite.” These patients instantly have access to the platform and its benefits.

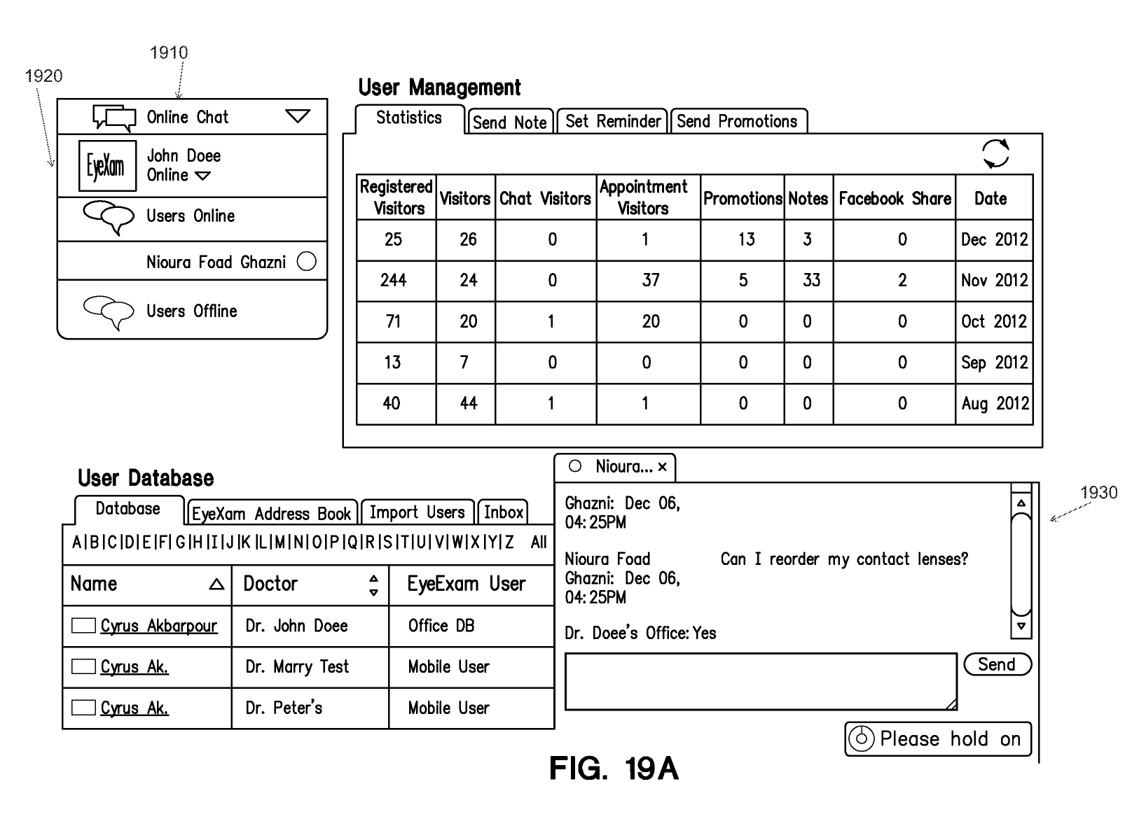

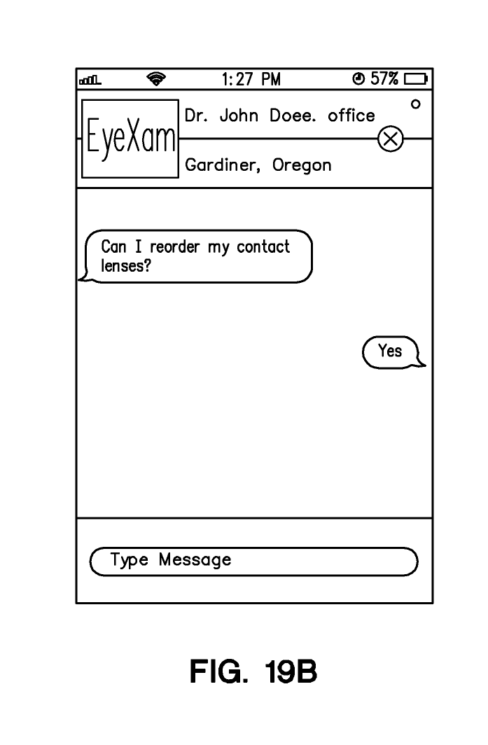

In one embodiment, a user can electronically chat with the office from the mobile App and a request is sent to the Dashboard in real-time as illustrated in FIGS. 19A-19B. The office will receive a notification in the Online Chat window 1910 of the Dashboard as illustrated in FIG. 19A. Offices can respond to the request by selecting the user's name from the list 1920. A pop-up window 1930 is displayed to receive and send chat messages forth and back between the user and office as illustrated in FIG. 19A. A similar chat session is displayed on the user's mobile device as illustrated in FIG. 19B. This allows for bi-directional real-time communication.

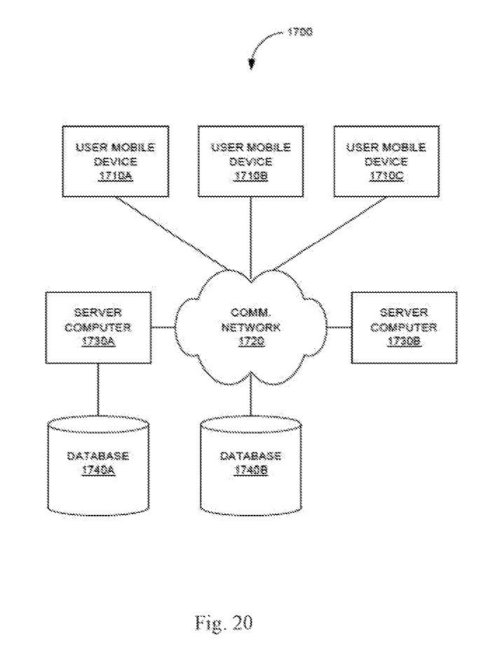

FIG. 20 is a simplified illustration of system 1700 that may incorporate an embodiment or be incorporated into an embodiment of any of the innovations, embodiments, and/or examples found within this disclosure. FIG. 20 is merely illustrative of an embodiment incorporating the present invention and does not limit the scope of the invention. One of ordinary skill in the art would recognize other variations, modifications, and alternatives.

In one embodiment, system 1700 includes one or more user mobile devices 1710 (e.g., computers 1710A, 1710B, and 1710C). User mobile devices 1710 can be smart phones with internet and GPS capability. These user mobile devices 1710 can also have any of a variety of applications, including one or more applications configured to perform methods of the invention. The user mobile devices 1710 are capable of communicating via a wireless network (e.g., communications network 1720). Although the exemplary system 1700 is shown with three user mobile devices, any number of user mobile devices can be supported.

Communications network 1720 can be any type of network familiar to those skilled in the art that can support data communications using any of a variety of commercially-available protocols, including without limitation TCP/IP, SNA, IPX, AppleTalk, and the like. Merely by way of example, communications network 1720 can include a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 1730 (e.g., computers 1730A and 1730B). Each of server computers 1730 may be configured with an operating system as well as any commercially-available server operating systems. Each of server computers 1730 may also be running one or more applications, which can be configured to provide services to one or more clients (e.g., user mobile devices 1710) and/or other servers (e.g., server computers 1730).

Merely by way of example, one of server computers 1730 may be a web server, which can be used, merely by way of example, to process requests for web pages or other electronic documents from user mobile devices 1710. The web server can also run a variety of server applications, including HTTP servers, FTP servers, CGI servers, database servers, Java servers, and the like. In some embodiments of the invention, the web server may be configured to serve Applications that can be operated on one or more of the user mobile devices 1710 to perform methods of the invention.

Server computers 1730, in some embodiments, might include one or more file and or/application servers, which can include one or more applications accessible by a client running on one of the user mobile devices 1710 and/or other server computers 1730. Merely by way of example, one or more of server computers 1730 can be one or more general purpose computers capable of executing programs or scripts in response to user mobile devices 1710 and/or other server computers 1730, including without limitation Applications (which might, in some cases, be configured to perform methods of the invention).

Merely by way of example, an application can be implemented as one or more scripts or programs written in any programming language, such as Java, C, or C++, and/or any scripting language, such as Perl, Python, or TCL, as well as combinations of any programming/scripting languages. The application server(s) can also include commercially available database servers, which can process requests from database clients running on one of user mobile devices 1710 and/or another of server computers 1730.

In accordance with further embodiments, one or more of server computers 1730 can function as a file server and/or can include one or more of the files necessary to implement methods of the invention incorporated by an Application running on one of user mobile devices 1710 and/or another of server computers 1730. Alternatively, as those skilled in the art will appreciate, a file server can include all necessary files, allowing such an application to be invoked remotely by one or more of user mobile devices 1710 and/or server computers 1730.

In certain embodiments, system 1700 can include one or more databases 1740 (e.g., databases 1740A and 1740B). The location of the database(s) 1740 is discretionary: merely by way of example, database 1740A might reside on a storage medium local to (and/or resident in) server computer 1730A. Alternatively, database 1740B can be remote from any or all server computers 1730, so long as it can be in communication (e.g., via communications network 1720) with one or more of these. For example, one of the databases may include information provided by an insurance carrier (e.g., VSP) on all optometrists that accept the insurance coverage provided by the insurance carrier. This information would be accessible to the user mobile devices 1710 and helps the users in locating an optometrist from the insurance carrier's network of optometrist.

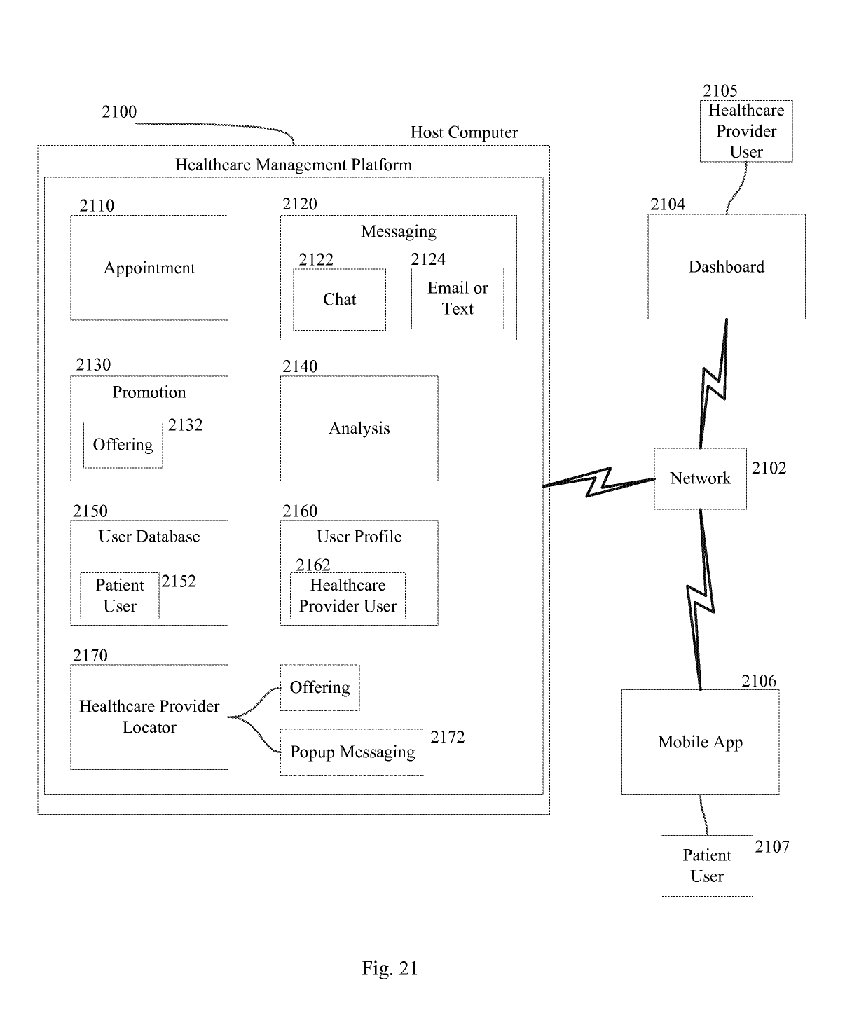

Referring to FIG. 21, in one embodiment, an exemplary mobile healthcare management system generally comprises a host computer 2100, a network 2102, a dashboard interface 2104, and a mobile user interface application (“App”) 2106. The dashboard is used by healthcare provider users 2105 to manage the system and interact with patient users 2107 via the healthcare management platform (“Platform”) residing in the host computer 2100. The host computer 2100 connects with the network 2102, which can be wired or wireless, or a combination of both. The Platform comprises an appointment module 2110, allowing a patient user 2107 to request an appointment with a health care provider user 2105 via the App 2106, and allowing the healthcare provider user 2105 to respond to the appointment request via the dashboard interface 2104. The Platform further comprises a messaging module 2120, allowing the patient user 2107 to communicate to the healthcare provider user 2105, and vice versa. The messaging module 2120 comprises two sub-modules, which are a real-time chat module 2122 and a email and SMS text messaging module 2124. The Platform further comprises a promotion module 2130, allowing the healthcare provider user 2105 to promote one or more offers to the patient user 2107, and allowing the patient user 2107 to respond to the offers, in real time. The promotion module 2130 further comprises an offering sub-module 2132, that is used by other modules in the Platform to promote one or more offers. The Platform further comprises an analytical module 2140, that analyses activities of the patient user and the healthcare provider user, and provides a plurality of statistics regarding the activities. The Platform further comprises a user database module 2150, that stores information regarding the patient user, and allows the healthcare provider user to manage the information via the dashboard interface 2104. The Platform further comprises a healthcare provider user profile module 2160, that contains information regarding the healthcare provider user 2105, and allows the patient user 2107 to view the information. The Platform further comprises a healthcare provider user locator module (“Locator”) 2170, that allows the patient user 2107 to locate a healthcare provider user 2105 based on the distance between the patient user and the healthcare provider user. The Locator 2170 uses a popup messaging feature 2172, that displays popup messages to the patient user 2107 when the patient user locates the healthcare provider user 2105. The Locator 2170 further utilizes the offering module 2132, which is the sub-module of the promotion module 2130, to promote one or more offers when the patient user 2107 locates the healthcare provider user 2105 via the Locator.

Although specific embodiments have been illustrated and described herein, it will be appreciated by those of ordinary skill in the art that any arrangement that is calculated or designed to achieve the same purposes may be substituted for the specific embodiments shown. Many adaptations of the disclosure will be apparent to those of ordinary skill in the art. Accordingly, this application is intended to cover any adaptations or variations of the disclosure.

1. A system to host an interaction platform for users comprising a network; a host computer; wherein said host computer is connected to said network wherein said host computer provides a healthcare management platform for one or more users to interact for the purpose of users interfacing management wherein said users are comprised of at least one healthcare provider user, at least one patient user, a mobile application interface module for said patient user to access said healthcare management platform, a dashboard interface module for said healthcare provider user to access said healthcare management platform, an appointment module allowing said patient user to request an appointment with said healthcare provider user via said mobile application interface module wherein said appointment module further allows said healthcare provider to respond to said appointment request via said dashboard interface module.

2. System of claim 1 wherein said healthcare management platform is further comprised of a messaging module wherein said messaging module allows said patient user to communicate to said healthcare provider user and allows for said healthcare provider user to communicate to said patient user.

3. System of claim 2 wherein said messaging module allows said patient user to communicate to said healthcare provider user via a real time chatting module in said mobile application interface module.

4. System of claim 2 wherein said messaging module allows said healthcare management user to communicate to said patient user via said dashboard interface module.

5. System of claim 2 wherein said messaging module allows said healthcare provider user to communicate to said patient user via email or SMS text messaging.

6. System of claim 1 wherein said healthcare management platform is further comprised of a promotion module wherein said promotion module allows said healthcare provider user to promote one or more offers to said patient user and allows said patient user to respond to said offers.

7. System of claim 6 wherein said promotion module allows said healthcare provider user to promote one or more offers to said patient user in real time and allows said patient user to respond to said offers in real time.

8. System of claim 6 wherein said promotion module allows a predetermined number of said offers wherein said patient user can respond to said offers.

9. System of claim 1 wherein said healthcare management platform is further comprised of an analytical module wherein said analytical module analyses activities of said patient user and said healthcare provider user and provides statics regarding said activities.

10. System of claim 1 wherein said healthcare management platform is further comprised of a user database module wherein said user database module stores information regarding said patient user and allows said healthcare provider user to manage said information via said dashboard interface module.

11. System of claim 1 wherein said healthcare management platform is further comprised of a messaging module wherein said messaging module allows said patient user to communicate to said healthcare provider user and allows for said healthcare provider user to communicate to said patient user.

12. System of claim 1 wherein said healthcare management platform is further comprised of a healthcare provider user profile module wherein said healthcare provider user profile module contains information regarding said healthcare provider user and allows said patient user to view said information regarding said healthcare provider user.

13. System of claim 1 wherein said healthcare management platform is further comprised of a healthcare provider user locator module wherein said patient user can locate said healthcare provider user base on the distance between said healthcare provider user and said patient user.

14. System of claim 13 wherein said healthcare provider locator module further comprises a pop up messaging module wherein said pop up messaging module automatically prompts requests to said patient user when patient user locates said healthcare provider user via said healthcare provider locator module.

15. System of claim 13 wherein said healthcare provider locator module further comprises a healthcare provider locator offering module wherein said healthcare provider locator offering module wherein said healthcare provider locator offering module promotes one or more offers.

16. System of claim 15 wherein said healthcare provider locator offering module promotes said offer when said patient user locates said healthcare provider user via said healthcare provider locator module.

17. A computer-implemented method for managing users interfacing between at least one patient user and at least one healthcare provider user, the method comprising of:
a. providing a network;
b. providing a host computer wherein said host computer is connected to said network wherein said host computer provides a healthcare management platform for one or more users to interact for the purpose of users interfacing management
c. wherein said users are comprised of at least one healthcare provider user and at least one patient user,
d. said healthcare management platform is comprised of a mobile application interface module for said patient user to access said healthcare management platform,
e. said healthcare management platform is comprised of a dashboard interface module for said healthcare provider user to access said healthcare management platform,
f. said healthcare management platform is further comprised of an appointment module allowing said patient user to request an appointment with said healthcare provider user via said mobile application interface module wherein said appointment module further allows said healthcare provider to respond to said appointment request via said dashboard interface module.

18. Method of claim 17 wherein said healthcare management platform is further comprised of a messaging module wherein said messaging module allows said patient user to communicate to said healthcare provider user and allows for said healthcare provider user to communicate to said patient user.

19. Method of claim 18 wherein said messaging module allows said patient user to communicate to said healthcare provider user via a real time chatting module in said mobile application interface module.

20. Method of claim 18 wherein said messaging module allows said healthcare management user to communicate to said patient user via said dashboard interface module.

21. Method of claim 18 wherein said messaging module allows said healthcare provider user to communicate to said patient user via email or SMS text messaging.

22. Method of claim 17 wherein said healthcare management platform is further comprised of a promotion module wherein said promotion module allows said healthcare provider user to promote one or more offers to said patient user and allows said patient user to respond to said offers.

23. Method of claim 22 wherein said promotion module allows said healthcare provider user to promote one or more offers to said patient user in real time and allows said patient user to respond to said offers in real time.

24. Method of claim 22 wherein said promotion module allows a predetermined number of said offers wherein said patient user can respond to said offers.

25. Method of claim 17 wherein said healthcare management platform is further comprised of an analytical module wherein said analytical module analyses activities of said patient user and said healthcare provider user and provides statics regarding said activities.

26. Method of claim 17 wherein said healthcare management platform is further comprised of a user database module wherein said user database module stores information regarding said patient user and allows said healthcare provider user to manage said information via said dashboard interface module.

27. Method of claim 17 wherein said healthcare management platform is further comprised of a messaging module wherein said messaging module allows said patient user to communicate to said healthcare provider user and allows for said healthcare provider user to communicate to said patient user.

28. Method of claim 17 wherein said healthcare management platform is further comprised of a healthcare provider user profile module wherein said healthcare provider user profile module contains information regarding said healthcare provider user and allows said patient user to view said information regarding said healthcare provider user.

29. Method of claim 17 wherein said healthcare management platform is further comprised of a healthcare provider user locator module wherein said patient user can locate said healthcare provider user base on the distance between said healthcare provider user and said patient user.

30. Method of claim 29 wherein said healthcare provider locator module further comprises a pop up messaging module wherein said pop up messaging module automatically prompts requests to said patient user when patient user locates said healthcare provider user via said healthcare provider locator module.

31. Method of claim 30 wherein said healthcare provider locator module further comprises a healthcare provider locator offering module wherein said healthcare provider locator offering module wherein said healthcare provider locator offering module promotes one or more offers.

32. Method of claim 31 wherein said healthcare provider locator offering module promotes said offer when said patient user locates said healthcare provider user via said healthcare provider locator module.
